(19) United States
(12) Patent Application Publication
(10) Pub. No.: US 2026/0254521 A1
(43) Pub. Date: Aug. 27, 2026

(54) MACHINE LEARNING BASED MMW BEAM MEASUREMENT

(71) Applicant: QUALCOMM Incorporated, San Diego, CA (US)

(72) Inventors: Jiaheng LIU, Shanghai (CN); Tom CHIN, San Diego, CA (US); Zhongsheng LI, Shanghai (CN)

(21) Appl. No.: 18/872,783

(22) PCT Filed: Jul. 29, 2022
(86) PCT No.: PCT/CN2022/108868

§ 371 Date: Dec. 6, 2024

(51) Int. Cl. H04B 7/06

(52) U.S. Cl. CPC H04B 7/06956

(57) ABSTRACT

A UE may measure metrics of a first subset of PO beams of at least one subset of PO beams including a plurality of PO beams from a network node, each subset of PO beams configured to form a PO pattern and the first subset of PO beams being associated with a first set of narrower RX beams of the UE, estimate metrics of the first set of narrower Rx beams using a ML model based on the metrics of the subset of PO beams, and identify at least one best Rx beam from the first set of narrower Rx beams, the at least one best Rx beam being associated with best estimated metrics among the first set of narrower Rx beams.

### TECHNICAL FIELD

The present disclosure relates generally to communication systems, and more particularly, to wireless communication including a machine learning (ML) based beam measurement.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a UE configured to measure metrics of a first subset of PO beams of at least one subset of PO beams including a plurality of PO beams from a network node, each subset of PO beams configured to form a PO pattern and the first subset of PO beams being associated with a first set of narrower RX beams of the UE, estimate metrics of the first set of narrower Rx beams using a ML model based on the metrics of the subset of PO beams, and identify at least one best Rx beam from the first set of narrower Rx beams, the at least one best Rx beam being associated with best estimated metrics among the first set of narrower Rx beams.

In an aspect of the disclosure, a method, a computer-readable medium, and an apparatus are provided. The apparatus may include a network entity configured to obtain at least one coefficient of a ML model for estimating a set of RX beams based on metrics of a subset of PO beams, and transmit the at least one coefficient associated with the ML model for a UE to estimate the metrics of the set of Rx beams using the ML model based on the at least one coefficient and metrics of a subset of PO beams.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is an example of the AI/ML algorithm of a method of wireless communication.

FIG. 5 illustrates an example of L1 level beam, L2 level beam, and L3 level beam.

FIG. 6 illustrates a UE including one or more antenna arrays for receiving at least one set of minimum viable PO beams (MVPs).

FIG. 7 is a diagram of L3 beam selection timeline.

FIGS. 8A and 8B are diagrams of L1 beam selections.

FIGS. 9A, 9B, and 9C are diagrams of L3 beam estimations.

FIG. 10 is a diagram of scheduling L3 beam estimation.

FIG. 11 is a call-flow diagram of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a diagram illustrating an example of a hardware implementation for an example apparatus and/or network entity.

FIG. 17 is a diagram illustrating an example of a hardware implementation for an example network entity.

### DETAILED DESCRIPTION

Beam forming is a feature associated with the 5G NR wireless communication. To refine a narrower Rx beams for the UE, the UE may be configured to select a Pseudo-omnidirectional (PO) beam (e.g., L1 beam), refine a network node transmit (Tx) beam (e.g., L2 beam) narrower than the PO beam, and then select the UE Rx beam (e.g., L3 beam) narrower than the network node Tx beam. Accordingly, selecting the UE Rx beam may take a long time and cause increased power consumption on the UE side. According to the aspects of the current disclosure, the UE may use a machine learning (ML) model to estimate or predict the L3 beam based on a set of metrics of a subset of PO beams.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

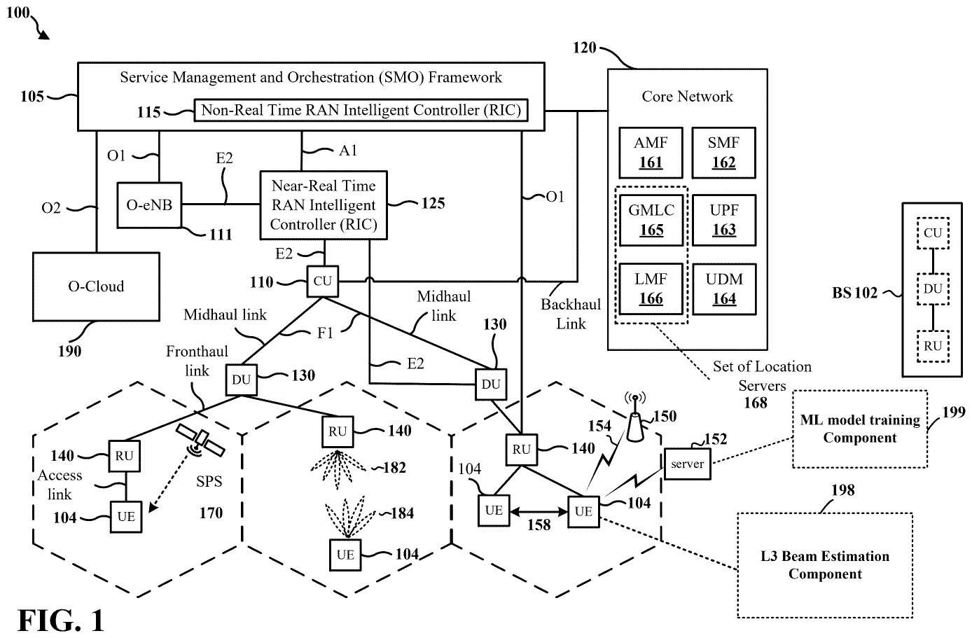

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The wireless communications system may further include a dedicated server 152 for training the AI/ML model used by the UE to estimate the L3 beam. The dedicated server 152 may be configured to directly communicate with the UE 104, or communicate with the UE 104 via the network (e.g., the core network 120 or the BS 102).

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an L3 beam estimation component 198 configured to measure metrics of a first subset of PO beams of at least one subset of PO beams including a plurality of PO beams from a network node, each subset of PO beams configured to form a PO pattern and the first subset of PO beams being associated with a first set of narrower RX beams of the UE, estimate metrics of the first set of narrower Rx beams using a ML model based on the metrics of the subset of PO beams, and identify at least one best Rx beam from the first set of narrower Rx beams, the at least one best Rx beam being associated with best estimated metrics among the first set of narrower Rx beams. In certain aspects, the base station 102 may include an ML model training component 199 configured to obtain at least one coefficient of a ML model for estimating a set of RX beams based on metrics of a subset of PO beams, and transmit the at least one coefficient associated with the ML model for a UE to estimate the metrics of the set of Rx beams using the ML model based on the at least one coefficient and metrics of a subset of PO beams. Although the following description may be focused on 5G NR, the concepts described herein may be applicable to other similar areas, such as LTE, LTE-A, CDMA, GSM, and other wireless technologies.

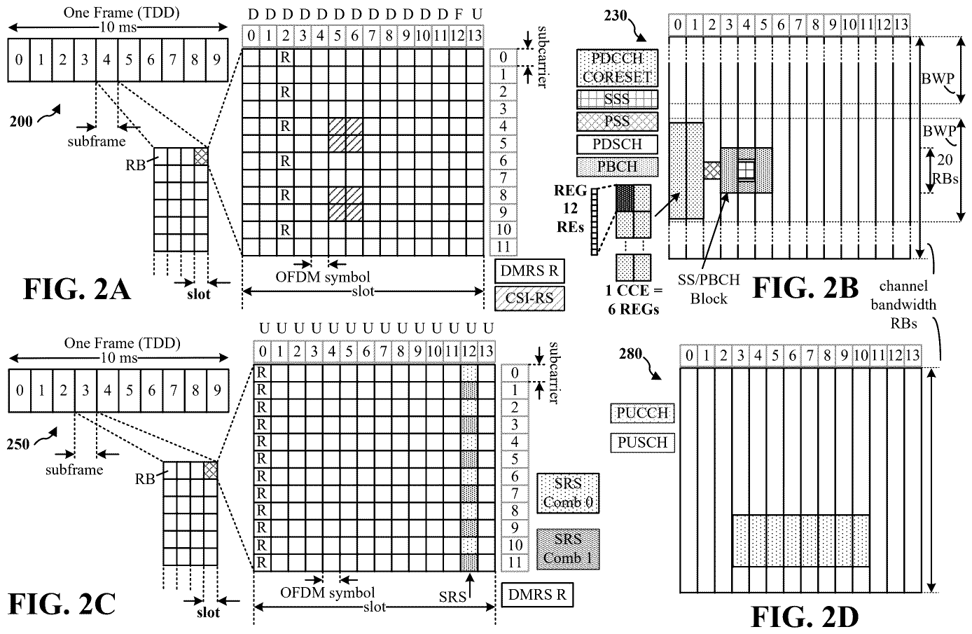

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 milliseconds (ms)) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

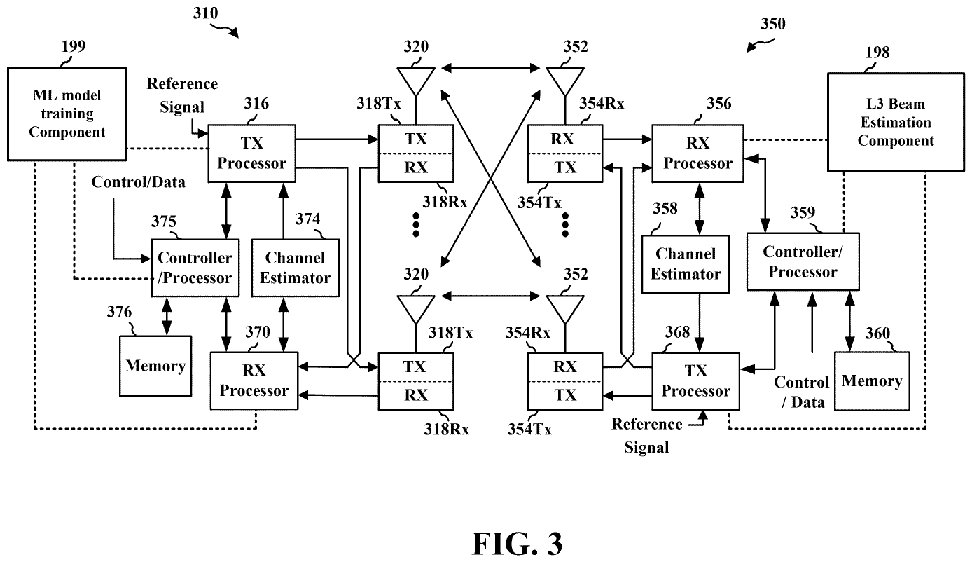

FIG. 3 is a block diagram of a server 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the server 310. These soft decisions may be based on channel estimates computed by the channel estimator 358. The soft decisions are then decoded and deinterleaved to recover the data and control signals that were originally transmitted by the server 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the server 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the server 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the server 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the L3 beam estimation component 198 of FIG. 1. At least one of the TX processor 316, the RX processor 370, and the controller/processor 375 may be configured to perform aspects in connection with the ML model training component 199 of FIG. 1.

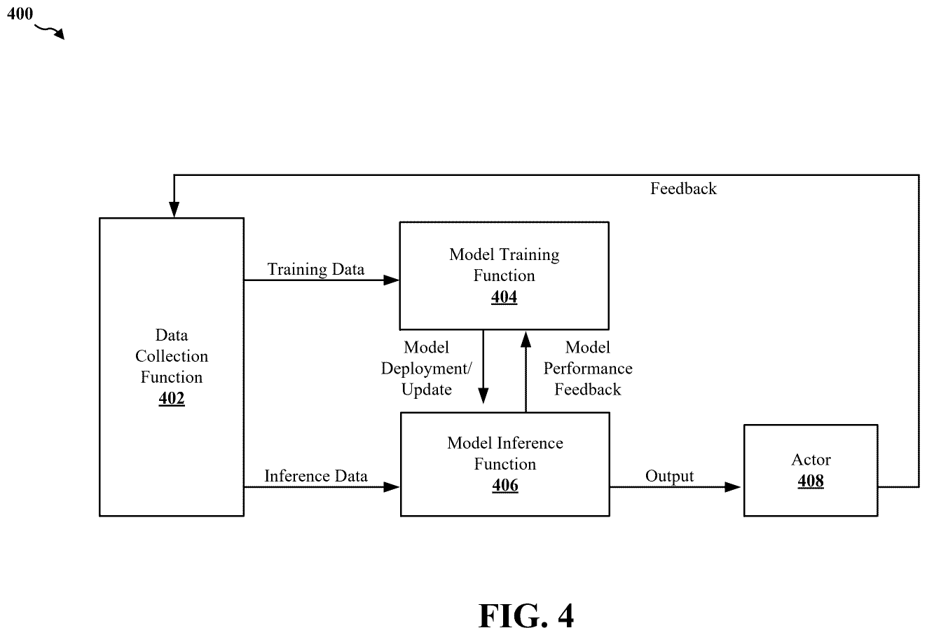

FIG. 4 is an example of the AI/ML algorithm 400 of a method of wireless communication. Here, the AI/ML algorithm 400 may be included in either the UE or the network node (e.g., the source network node or the target network node of the handover procedure) to provide the AI/ML based mobility related prediction. The AI/ML algorithm 400 may include various functions including a data collection function 402, a model training function 404, a model inference function 406, and an actor 408.

The data collection function 402 may be a function that provides input data to the model training function 404 and the model inference function 406. The data collection function 402 may include any form of data preparation, and it may not be specific to the implementation of the AI/ML algorithm (e.g., data pre-processing and cleaning, formatting, and transformation). The examples of input data may include, but not limited to, measurements from network entities including UEs or network nodes, feedback from the actor 408, output from another AI/ML model. The data collection function 402 may include training data, which refers to the data to be sent as the input for the model training function 404, and inference data, which refers to be sent as the input for the model inference function 406.

The model training function 404 may be a function that performs the ML model training, validation, and testing, which may generate model performance metrics as part of the model testing procedure. The model training function 404 may also be responsible for data preparation (e.g. data pre-processing and cleaning, formatting, and transformation) based on the training data delivered or received from the data collection function 402. The model training function 404 may deploy or update a trained, validated, and tested AI/ML model to the model inference function 406, and receive a model performance feedback from the model inference function 406.

The model inference function 406 may be a function that provides the model inference output (e.g. predictions or decisions). The model inference function 406 may also perform data preparation (e.g. data pre-processing and cleaning, formatting, and transformation) based on the inference data delivered from the data collection function 402. The output of the model inference function 406 may include the inference output of the AI/ML model produced by the model inference function 406. The details of the inference output may be use-case specific.

The model performance feedback may refer to information derived from the model inference function 406 that may be suitable for improvement of the AI/ML model trained in the model training function 404. The feedback from the actor 408 or other network entities (via the data collection function 402) may be implemented for the model inference function 406 to create the model performance feedback.

The actor 408 may be a function that receives the output from the model inference function 406 and triggers or performs corresponding actions. The actor 408 may trigger actions directed to network entities including the other network entities or itself. The actor 408 may also provide a feedback information that the model training function 404 or the model inference function 406 to derive training or inference data or performance feedback. The feedback may be transmitted back to the data collection function 402.

A UE and/or network entity (centralized and/or distributed units) may use machine-learning algorithms, deep-learning algorithms, neural networks, reinforcement learning, regression, boosting, or advanced signal processing methods for aspects of wireless communication, e.g., with a base station, a TRP, another UE, etc.

In some aspects described herein, an encoding device (e.g., a UE) may train one or more neural networks to learn dependence of measured qualities on individual parameters. Among others, examples of machine learning models or neural networks that may be comprised in the UE and/or network entity include artificial neural networks (ANN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; bayesian networks; genetic algorithms; Deep convolutional networks (DCNs) configured with additional pooling and normalization layers; and Deep belief networks (DBNs).

A machine learning model, such as an artificial neural network (ANN), may include an interconnected group of artificial neurons (e.g., neuron models), and may be a computational device or may represent a method to be performed by a computational device. The connections of the neuron models may be modeled as weights. Machine learning models may provide predictive modeling, adaptive control, and other applications through training via a dataset. The model may be adaptive based on external or internal information that is processed by the machine learning model. Machine learning may provide non-linear statistical data model or decision making and may model complex relationships between input data and output information.

A machine learning model may include multiple layers and/or operations that may be formed by concatenation of one or more of the referenced operations. Examples of operations that may be involved include extraction of various features of data, convolution operations, fully connected operations that may be activated or deactivates, compression, decompression, quantization, flattening, etc. As used herein, a “layer” of a machine learning model may be used to denote an operation on input data. For example, a convolution layer, a fully connected layer, and/or the like may be used to refer to associated operations on data that is input into a layer. A convolution AxB operation refers to an operation that converts a number of input features A into a number of output features B. “Kernel size” may refer to a number of adjacent coefficients that are combined in a dimension. As used herein, “weight” may be used to denote one or more coefficients used in the operations in the layers for combining various rows and/or columns of input data. For example, a fully connected layer operation may have an output y that is determined based at least in part on a sum of a product of input matrix x and weights A (which may be a matrix) and bias values B (which may be a matrix). The term “weights” may be used herein to generically refer to both weights and bias values. Weights and biases are examples of parameters of a trained machine learning model. Different layers of a machine learning model may be trained separately.

Machine learning models may include a variety of connectivity patterns, e.g., including any of feed-forward networks, hierarchical layers, recurrent architectures, feedback connections, etc. The connections between layers of a neural network may be fully connected or locally connected. In a fully connected network, a neuron in a first layer may communicate its output to each neuron in a second layer, and each neuron in the second layer may receive input from every neuron in the first layer. In a locally connected network, a neuron in a first layer may be connected to a limited number of neurons in the second layer. In some aspects, a convolutional network may be locally connected and configured with shared connection strengths associated with the inputs for each neuron in the second layer. A locally connected layer of a network may be configured such that each neuron in a layer has the same, or similar, connectivity pattern, but with different connection strengths.

A machine learning model or neural network may be trained. For example, a machine learning model may be trained based on supervised learning. During training, the machine learning model may be presented with input that the model uses to compute to produce an output. The actual output may be compared to a target output, and the difference may be used to adjust parameters (such as weights and biases) of the machine learning model in order to provide an output closer to the target output. Before training, the output may be incorrect or less accurate, and an error, or difference, may be calculated between the actual output and the target output. The weights of the machine learning model may then be adjusted so that the output is more closely aligned with the target. To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error or to move the output closer to the target. This manner of adjusting the weights may be referred to as back propagation through the neural network. The process may continue until an achievable error rate stops decreasing or until the error rate has reached a target level.

The machine learning models may include computational complexity and substantial processor for training the machine learning model. An output of one node is connected as the input to another node. Connections between nodes may be referred to as edges, and weights may be applied to the connections/edges to adjust the output from one node that is applied as input to another node. Nodes may apply thresholds in order to determine whether, or when, to provide output to a connected node. The output of each node may be calculated as a non-linear function of a sum of the inputs to the node. The neural network may include any number of nodes and any type of connections between nodes. The neural network may include one or more hidden nodes. Nodes may be aggregated into layers, and different layers of the neural network may perform different kinds of transformations on the input. A signal may travel from input at a first layer through the multiple layers of the neural network to output at a last layer of the neural network and may traverse layers multiple times.

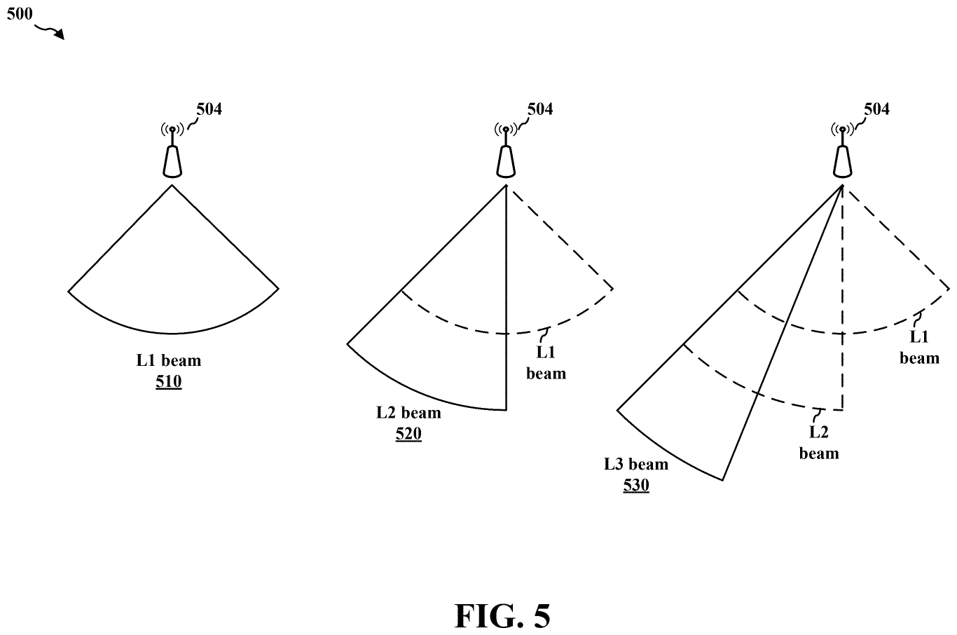

FIG. 5 illustrates an example 500 of an L1 level beam, an L2 level beam, and an L3 level beam. In some aspects, to support a mmWave (mmW) communication, the network node 504 and the UE may perform beam forming using more than one sets of beams including different beam levels with different configurations. For example, the beams may include the L1 level beam (e.g., L1 beam 510), the L2 level beam (e.g., L2 beam 520), and the L3 level beam (e.g., L3 beam 530).

First, the L1 beam 510 may be used for initial beam selection. For example, the L1 beam 510 may be an SSB beam, e.g., a beam direction in which an SSB signal is transmitted. The network node 504 may perform an SSB beam sweeping by transmitting a set of SSBs in different directions and/or angles to facilitate beam forming. The network node 504 may sweep the beams and the UE may select one beam and report the selected beam to the network node 504.

One or more L2 beams 520 may be used for beam refinement for the network node 504, each L2 beam may be narrower than the L1 beam. An L2 beam 520 may be referred to as the network node 504 transmit (Tx) beam. After the beam selection using the L1 beam 510, the network node 504 and the UE may perform the network node 504 Tx beam refinement using the L2 beam 520. The L2 beam 520 may be CSI-RS beam, e.g., a CSI-RS may be transmitted on the beam and measured for the beam refinement. That is, the network node 504 may transmit a set of L2 beams carrying a set of CSI-RSs based on the L1 beam 510 selected by the UE. Here, the L2 beams may be transmitted within the selected L1 beam 510. That is, the L2 beam 520 may be narrower than the L1 beam 510, and the UE may perform measurements on the CSI-RS received at narrower beams within the selected L1 beam 510 selected at the UE for the beam pair link.

The L3 level beam may be used for beam refinement for the UE. The L3 beam 530 may be referred to as the UE receive (Rx) beam. After the beam selection using the L1 beam 510 and the network node 504 Tx beam refinement using the L2 beam 520, the network node 504 and the UE may perform the UE Rx beam refinement using one or more L3 beams. The L3 beam 530 may have a narrower angle, e.g., than the L1 beam and/or the L2 beam, and may have the most accurate beam level for the mmW measurement among the L1, L2, and L3 beams. Within the L2 beam 520 selection, the UE may refine the UE Rx beam and set the spatial filter on the Rx antenna array. The L3 beam 530 may have the highest gain among the L1 beam 510, the L2 beam 520, and the L3 beam 530, and may extend the cell range of the wireless communication.

As the L3 beams are narrower beams, the network node 504 and the UE may be configured with a relatively larger number of L3 beams, and if the L3 beam 530 is configured in a codebook, the network node 504 and the UE may not be able to, or it may take a long time to, sweep through a complete list of the L3 beams (e.g., round robin method), compared to the L1 beam 510. The network node 504 and the UE may configure an intelligent algorithm to select a subset of L3 beams for sweeping.

Here, the L1 beam 510 may also be referred to as a Pseudo-omnidirectional (PO) beam, and the L1 beam 510 may have a relatively bigger angular range (e.g., 90 degree or 60 degree) depending on a number of PO beams supported by the UE. The L2 beam 520 may have an angular range smaller than the L1 beam 510 (e.g., half of the angle range of the L1 beam 510). The L3 beam 530 may have even smaller angular range than the L2 beam 520 (e.g., half of the angle range of the L2 beam 520).

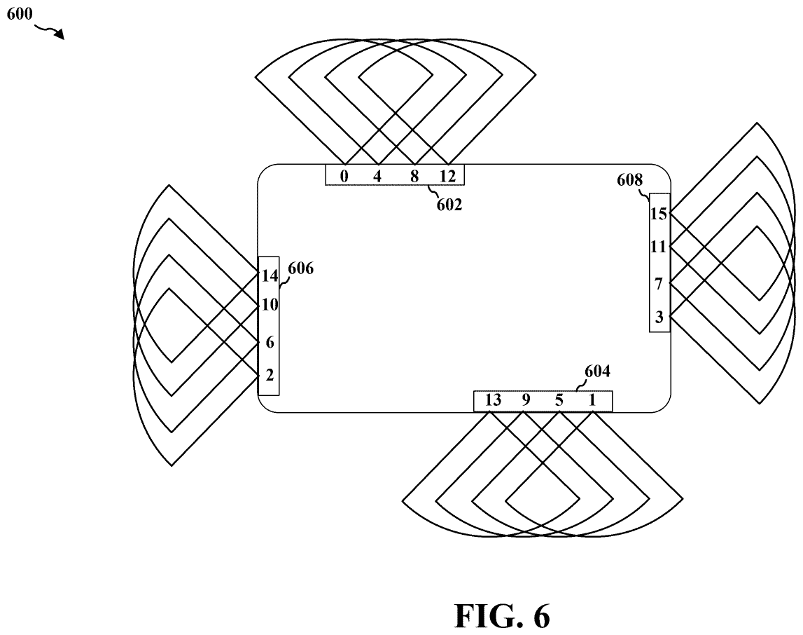

FIG. 6 illustrates a UE 600 including one or more antenna arrays for receiving at least one set of minimum viable PO beams (MVPs). Here, the MVP set may refer to a set of PO beams that may form a PO pattern. For example, for a PO beam having an angular range of 90 degrees, a MVP set may include four (4) PO beams to form the PO pattern. The UE 600 600 may include a plurality of antenna array panels 602, 604, 606, and 608. The UE 600 may configure the one or more antenna array panels 602, 604, 606, and 608 for receiving the directional PO beams. That is, the UE 600 may include one or more antenna array panels, and each antenna panel may be configured to receive at least one directional beam.

For example, a first set of MVP may include the PO beams with index 0, 1, 2, and 3, a second set of MVP may include the PO beams with index 4, 5, 6, and 7, a third set of MVP may include the PO beams with index 8, 9, 10, and 11, and a fourth set of MVP may include the PO beams with index 12, 13, 14, and 15. Here, the PO beams may be L1 beams. Here, the first antenna array panel 602 may be configured to receive the PO beams with index 0, 4, 8, and 12, the second antenna array panel 604 may be configured to receive the PO beams with index 1, 5, 9, and 13, the third antenna array panel 606 may be configured to receive the PO beams with index 2, 6, 10, and 14, and the fourth antenna array panel 608 may be configured to receive the PO beams with index 3, 7, 11, and 15.

For the UE 600 to find the best L3 beam, the UE 600 may spend a long amount of time to perform the L1 beam selection of the PO beams using a big antenna array, and then to refine the beam selection using the associated L2 beams and the L3 beams. The amount of time used to find the best L3 beam may reduce performance at the UE, and performing the beam measurement for the L1, L2, and L3 level beam selection/refinement may consume significant amounts of power at the UE.

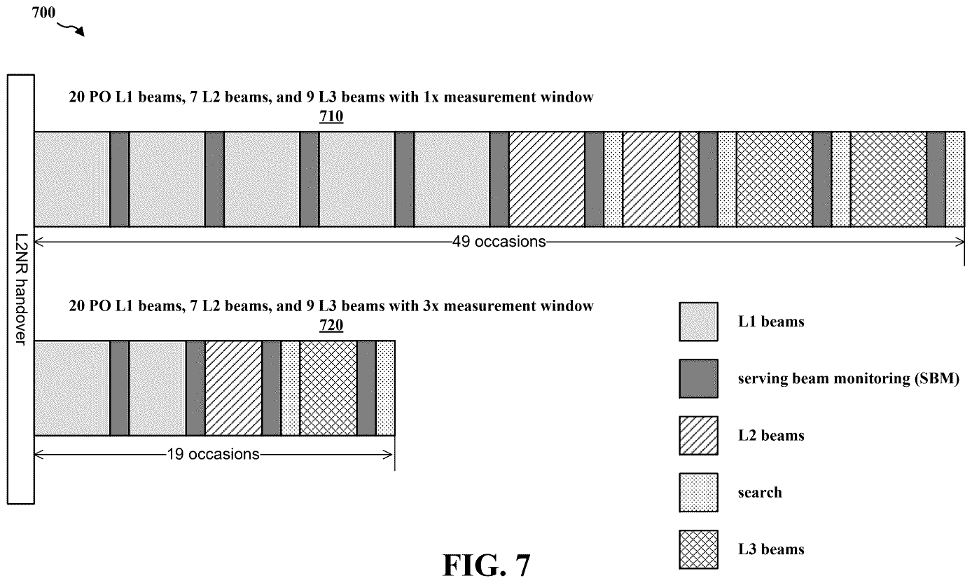

FIG. 7 is a diagram 700 of an L3 beam selection timeline. The diagram 700 includes a first timeline 710 of a first UE configured with a measurement window to measure one beam per a single occasion (e.g., 1× measurement window), and a second timeline 720 of a second UE configured with a measurement window to measure three (3) beams per a single occasion (e.g., 3× measurement window). Here, the PO L1 beams may include 20 PO L1 beams, each PO L1 beams including seven (7) L2 beams, and each L2 beams including nine (9) L3 beams.

Until the UE selects the proper L3 beam, the UE may be configured with an L3 beam having a relatively lower measurement. The longer the time taken for L3 beam selection corresponds to a longer time that the UE uses the lower quality L3 beam with the relatively lower measurement.

To complete the L3 beam selection, the UE may perform measurements of the 20 PO beams (e.g., L1 beams), perform serving beam monitoring (SBM), perform measurements of the seven (7) L2 beams and measurements of the nine (9) L3 beams, including a number of search occasions for the identified best L2 and best L3 beams based on the measurements of the L2 and L3 beams.

The first UE of the first timeline 710 may take 25 occasions to perform the measurements of the 20 PO beams (e.g., L1 beams) and five (5) SBM occasions injected in between. The second UE of the second timeline 720 may take nine (9) occasions to perform the measurements of the 20 PO beams (e.g., L1 beams) and two (2) SBM occasions injected in between. The first UE of the first timeline 710 may take 24 occasions to perform the measurements of the seven (7) L2 beams and nine (9) L3 beams with four (4) SBM occasions and four (4) search occasions injected in between. The second UE of the second timeline 720 may take 10 occasions to perform the measurements of the measurements of the seven (7) L2 beams and nine (9) L3 beams with two (2) SBM occasions and two (2) search occasions injected in between. Accordingly, to reach the best L3 beam, the first UE of the first timeline 710 may take 49 occasions (e.g., at least 980 ms) or the second UE of the second timeline 720 may take 19 occasions (e.g., at least 380 ms). Performing the complete L3 beam selection may incur a huge power consumption for each frequency measurement.

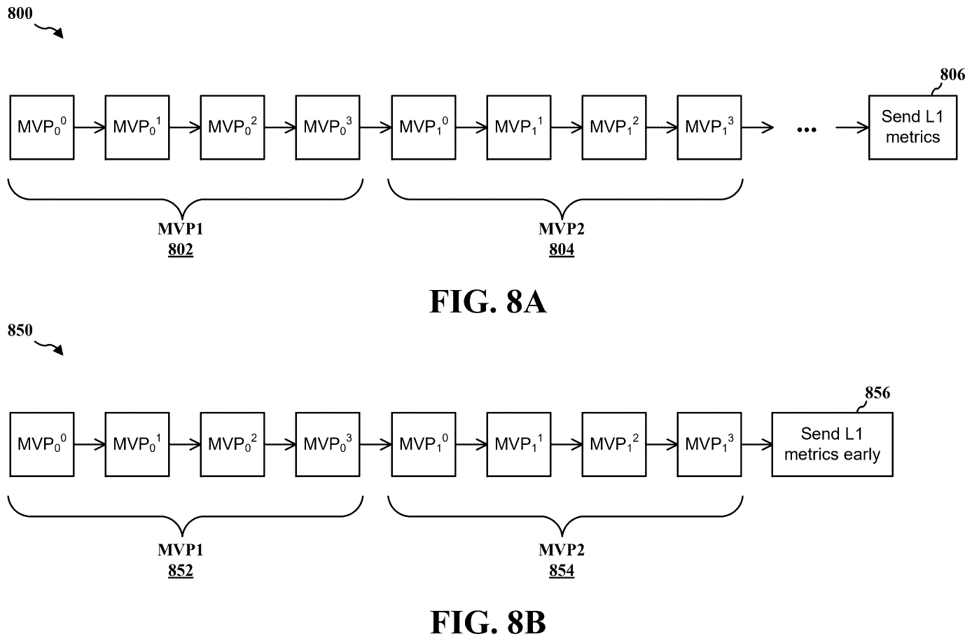

FIGS. 8A and 8B are diagrams 800 and 850 of L1 beam selections. The UE may be configured to monitor or measure 20 PO beam pairs including five (5) MVP sets, each set of MVP including four (4) PO beams that may form PO pattern. The UE may measure each MVP set, until 1) complete the measurement of all of 20 PO beams, 2) meet early-exit criteria for the mmW beam, or 3) a timer for the beam forming expires.

The diagram 800 of L1 beam selection includes a full measurement of the 20 PO beams. The UE may perform a first measurement of the first MVP set 802, a second measurement of the second MVP set 804, and so on, to a fifth measurement of the fifth MVP set. Based on the measurements of the first MVP set to the fifth MVP set, the UE may send the measured metrics of the OP beams (e.g., the L1 beams) to the network node at 806 for the beam selection based on the PO beams.

Here, the metric may refer to at least one measurement of the received reference signal (RS). For example, the metric may include, but not limited to, a received signal strength indicator (RSSI), a reference signal received power (RSRP), a reference signal received quality (RSRQ), a signal to interference plus noise ratio (SINR), a signal to noise plus interference ratio (SNIR), or a signal to noise ratio (SNR).

The diagram 850 of L1 beam selection includes an early termination of the PO beam measurements based on the early-exit criteria. The UE may be configured with a threshold value associated with the L1 beam metric, and the UE may stop the measurements of the L1 beams once the UE measures that one of the L1 beams (e.g., the PO beams) may have a metric greater than the threshold value associated with the L1 beam metric. Here, the threshold value may be referred to as the early-exit criteria, and the UE may stop measuring the L1 beams and send the L1 metrics to the network node at 856. For example, the UE may perform a first measurement of the first MVP set 852 and a second measurement of the second MVP set 854, and determine that a metric of one L1 beam of the first MVP set 852 and the second MVP set 854 meets the early-exit criteria. Based on determining that the metric of the one L1 beam meets the early-exit criteria, the UE may stop the L1 beam measurement, and send the metrics of the L1 beams to the network node for the beam selection based on the PO beams.

In some aspects, the UE may be configured to estimate the L3 beam based on a set of metrics of the L1 beams. That is, the UE may measure at least a MVP set to measure metrics of the L1 beams, and estimate the best L3 beam based on the metrics of the MVP set. The UE may include an AI/ML model configured to estimate the best L3 beam based on the metrics of the at least one MVP set, and the UE may use the AI/ML model to estimate the best L3 beam based on the metrics of the at least one MVP set. The AI/ML model may further estimate the metric of the estimated L3 beam, and the UE may determine whether to early-exit from the L1 beam selection based on the metrics of the at least one MVP set. Based on the estimated best L3 beam, the UE may search for the best L3 beam estimated by the AI/ML and set the spatial filter on the Rx antenna array to communicate the network node with the refined beam.

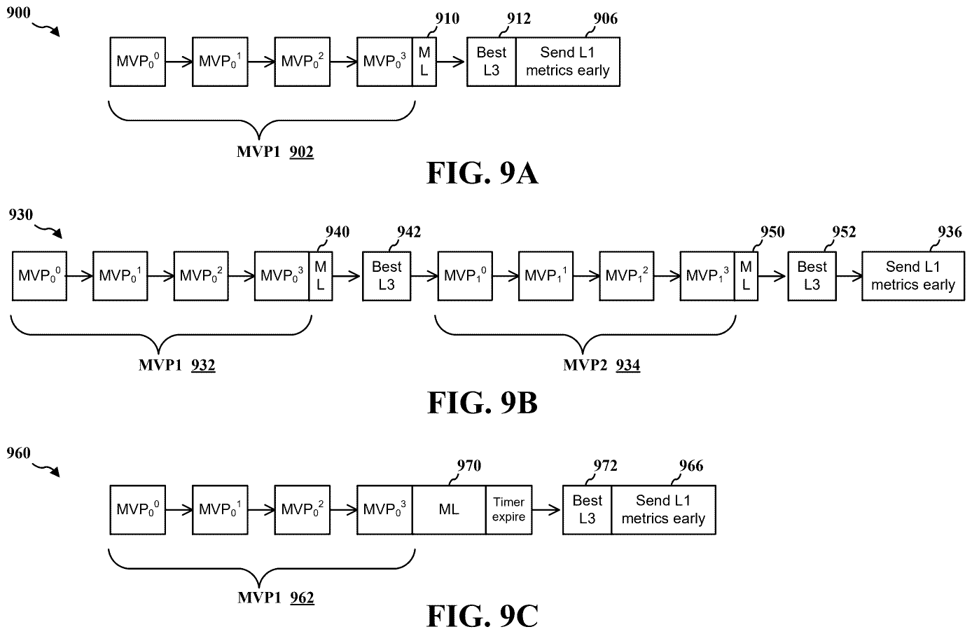

FIGS. 9A, 9B, and 9C are diagrams 900, 930, and 960 of L3 beam estimations. After each set of 4 beams is measured in successive mmW SSB occasions, the UE may request the prediction engine (e.g., AI/ML model) to use the measurements of the set of 4 beams to give an estimated best L3 Beam. That is, the UE may be configured to include the AI/ML model for estimating the best L3 beam based on metrics of at least one MVP set.

FIG. 9A is a diagram 900 of L3 beam estimation based on metrics of the first MVP set 902. The UE may input the metrics of the first MVP set 902 to the AI/ML model at 910, and the AI/ML model may estimate the best L3 beam 912 based on the metrics of the first MVP set 902. Based on the estimated L3 beam having a sufficient quality (e.g., metric greater than the threshold value), the UE may send the metrics to network node early and exit the PO beam sweep. At 906, based on the estimated best L3 beam 912, the UE may send the metrics of the first MVP set 902 to the network node for L1 beam selection, and further more refine the Rx beam of the UE based on the best L3 beam estimated by the AI/ML model.

Based on the predicted best beam not having a sufficient quality (e.g., metric less than or equal to the threshold value), the UE may continue with the next MVP set and send the full PO beam measurement to the machine learning engine afterwards.

FIG. 9B is a diagram 930 of L3 beam estimation based on metrics of the first MVP set 932 and a second MVP set 934. The UE may input the metrics of the first MVP set 932 to the AI/ML model 940, and the AI/ML model 940 may estimate the best L3 beam 942 based on the metrics of the first MVP set 932. Based on the predicted best beam not having a sufficient quality (e.g., metric less than or equal to the threshold value), the UE may continue with the next MVP set. The UE may input the metrics of the first MVP set 932 and the second MVP set 934 to the AI/ML model 950, and the AI/ML model 950 may estimate the best L3 beam 952 based on the metrics of the first MVP set 932 and the second MVP set 934. Based on the L3 beam estimated at 950 having a sufficient quality (e.g., metric greater than the threshold value), the UE may send the metrics of the first MVP set 932 and the second MVP set 934 to the network node early and exit the PO beam sweep at 936. At 936, the UE may send the metrics of the first MVP set 932 and the second MVP set 934 to the network node for the L1 beam selection, and further more refine the Rx beam of the UE based on the best L3 beam 952 estimated by the AI/ML model 950.

In one aspect, the AI/ML model may run past the beam selection point. In one example, the UE may use the occasion for the next MVP set. In another example, if the timeline is completely overrun by the AI/ML model, the UE may lose the occasion. FIG. 9C is a diagram 960 of the L3 beam estimation based on metrics of the first MVP set 962 based on an expiration of a timer. Here, the timer may be a beam selection timer. The UE may input the metrics of the first MVP set 962 to the AI/ML model 970, and the AI/ML model may estimate the best L3 beam 972 based on the metrics of the first MVP set 962. In one case, the beam selection timer may expire, and the UE may determine to exit the L1 beam selection. The UE may obtain the best L3 beam 972 by the AI/ML model 970 based on the metrics of the first MVP set 962, and UE may send the metrics to network node and exit the PO beam sweep. At 966, based on the estimated best L3 beam 972, the UE may send the metrics of the first MVP set 962 to the network node for L1 beam selection, and further more refine the Rx beam of the UE based on the best L3 beam estimated by the AI/ML model.

The machine learning algorithm may be embedded into a digital signal processor (DSP) of the UE, and the UE may obtain the configuration of the AI/ML model from a network calibration configuration embedded in the DSP. For example, the configuration of the AI/ML model may include the AI/ML model coefficient for establishing the best L3 beam and its metric based on the measured metrics of the set of L1 beams (e.g., the PO beams). In one example, the best L3 beam may be deduced per static prediction coefficient and the measured set of L1 beams. The estimation of the L3 beams may have improved accuracy based on an increased number of metrics from the set of L1 beams. Furthermore, the AI/ML model may be trained using the measurements of the set of L1 beams to provide improved accuracy in estimating the best L3 beams and their metrics.

In some aspects of the current disclosure, the UE may refine the L3 beam using the AI/ML model, such as the model described in connection with FIG. 4, based on the L1 beam measurement, and reduce the processing time and power consumption for the L2 beam and L3 beam measurement and sweeping.

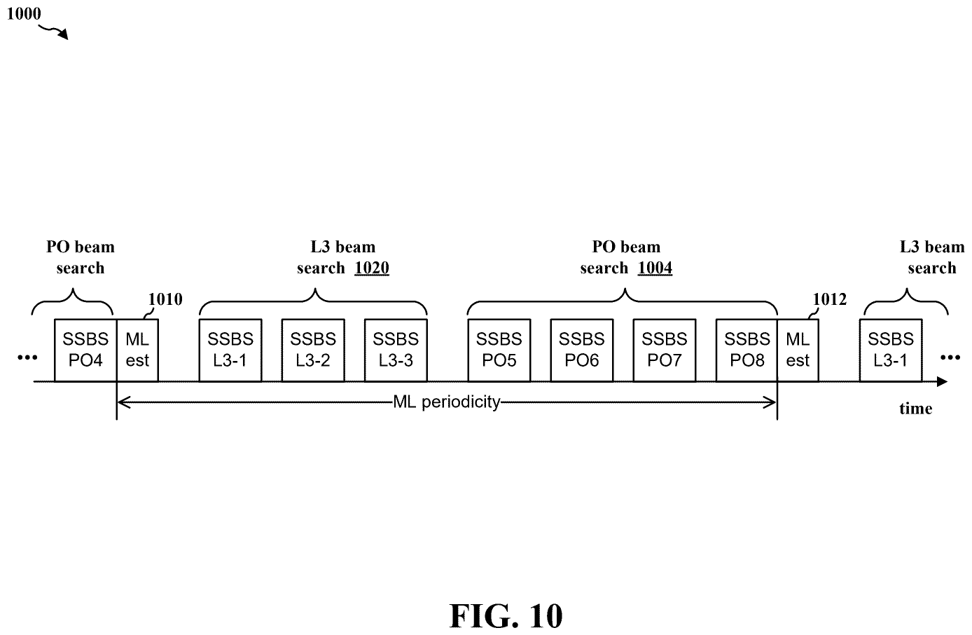

FIG. 10 is a diagram 1000 of scheduling L3 beam estimation. The ML prediction (or estimation) periodicity may be configured based on a number of PO beams per each MVP set, a number of L3 scheduling, and the search periodicity. That is, the periodicity of the AI/ML estimation of the L3 beam may be based on at least the number of PO beams per each MVP set, the number of L3 scheduling, and the search periodicity. Here, the periodicity of the L3 beam estimation may be represented as (Number of PO beams per MVP set+Number of L3 scheduling)*search periodicity. Here, the number of PO beams per each MVP set may be configured based on the number of PO beams that the UE may support, and the number of L3 scheduling may be configured based on the UE's ability. For example, the diagram 1000 shows that the number of PO beams per MVP set may be four (4) (e.g., four (4) PO beams in each MVP set), and the number of L3 Beam scheduling may be three (3). The AI/ML periodicity may be configured between a first ML estimation 1010 and a second ML estimation 1012 including three (3) occasions of the L3 beam search 1020 and four (4) occasions of the PO beam search 1004.

In one aspect, the AI/ML model estimation may be requested based on expiration of an ML estimation timer. That is, the UE may include the ML estimation timer, and perform the ML estimation of the L3 beam based on expiration of the ML estimation timer. For example, the UE may initiate the ML estimation timer, and while the ML estimation timer lapses, the UE may measure the L1 beams (e.g., PO beams). Upon expiration of the ML estimation timer, the UE may run the AI/ML model to estimate the best L3 beams and their metrics based on the measured L1 beams.

In another aspect, the AI/ML model estimation may be requested based on a metric of the neighboring cell being greater than the serving cell by a threshold value. For example, the UE may be configured to request the AI/ML model estimation of the best L3 beam based on a difference between a best PO beam metric of the neighboring cell and a best PO beam metric of the serving cell (e.g., best neighboring cell's best PO RSRP—serving cell's best PO RSRP) being greater than a threshold value. (e.g., best neighboring cell's best PO RSRP—serving cell's best PO RSRP>an offset+2 dB). That is, based on the metric of the best L1 PO beam of the neighboring cell being greater than the metric of the best L1 PO beam of the serving cell by a threshold value, the machine learning request may be requested based on all of measured metrics (e.g., RSRP) of the PO beams from the serving cell and the neighboring cells.

In some aspects, at the machine learning confirmation, the measurement scheduler may sort and pick the top N L3 beams estimated for subsequent search scheduling. That is, based on the outcome of the estimated metrics of the L3 beams, the UE may pick a set of top N3 beams and perform an L3 beam search. For example, the UE may be configured to pick top three (3) estimated L3 beams with the top three (3) greatest estimated metrics. Based on the estimation of the L3 beam metrics, the UE may determine at least one best L3 beam, and schedule the estimated best L3 beam. That is, the UE may measure for the estimated best L3 beams during a static search procedure.

In one aspect, during the static search procedure, if the UE detects that the estimated best L3 beams are present, the UE may assign higher priority for scheduling that the PO beam (e.g., the L1 beam). That is, the UE may be configured to assign higher priority to the estimated best L3 beams for scheduling the wireless communication.

In another aspect, the UE may configure an allowed beam list to include the estimated L3 beams. That is, the UE may be configured to use the best L3 beams to schedule the wireless communication. If the UE determines that the best L3 beams are disallowed beams, the UE may continue scheduling the wireless communication on the PO beams (e.g., the L1 beams).

In another aspect, once the L3 estimated beams are scheduled, the UE may resume to scheduling the PO beams. The UE may schedule the estimated L3 beams on the component carrier identifier (CC ID) on which the AI/ML estimation request was initiated. For example, if the AI/ML estimation was requested based on the best neighboring cells, the UE may schedule the estimated L3 beams on the CC ID of the best neighbor cells.

Based on the AI/ML based estimation of the L3 beams based on measurements of the L1 beams (e.g., MVP set), the UE may choose the best L3 beam in a small (or shorter timeline) MVP measurement round, with relatively small time cost and power consumption. The UE may also quickly enter the connected mode with the best L3 beam based on the AI/ML estimation based on the known metric of the L1 beams. Since the L3 beam is estimated during the L1 beam selection procedure, the L3 beam refinement may automatically start early with neighbors and parent's neighbors. Accordingly, the UE may select the best PO beam with the advantage of the UE being already on the best L3 beam (e.g., the Rx beam).

In some aspects, the AI/ML model of the UE for L3 estimation may be configured with the corresponding coefficient for the AI/ML learning algorithm. The AI/ML estimation model may be configured with a default set of parameters generated as a part of the hardware design. Here, the default set of parameters may be based on measured electric field data and/or codebook designed from the measured L1 beam metrics. Furthermore, the parameters or coefficients of the AI/ML model may be generated by a network entity and transmitted to the UE for implementation. That is, the network entity (e.g., a dedicated server) may include an AI/ML model trainer, and generate the AI/ML model parameter or coefficients for the AI/ML model of the UE. For example, a dedicated server may be configured to receive a set of data from the UE including the measured L1 metrics and/or the outcome of the AI/ML model, and trainer the AI/ML model based on the set of data received from the UE. The UE may input and output data handled via the network based beam characterization application.

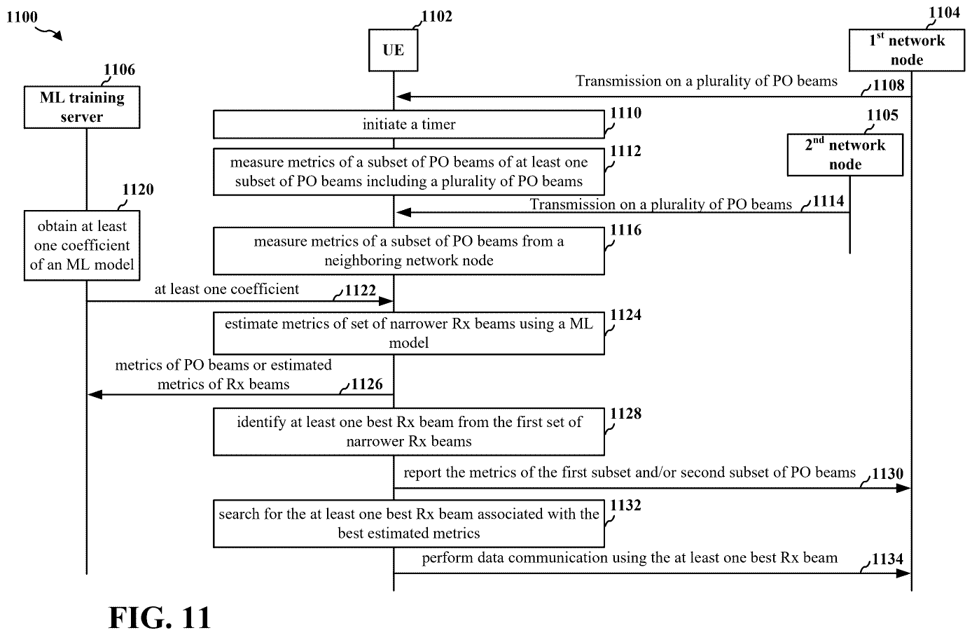

FIG. 11 is a call-flow diagram 1100 of a method of wireless communication. The call-flow diagram 1100 may include a UE 1102 a first network node 1104, a second network node 1105, and an ML training server 1106. Here, the first network node 1104 may be associated with a serving cell and the second network node 1105 may be associated with a neighboring cell of the serving cell. The UE 1102 may measure metrics of at least one MVP set (e.g., including the L1 beams) from a network node (e.g., the first network node 1104 or the second network node 1105), estimate metrics of a set of narrower Rx beams (e.g., the L3 beams) using a ML model based on the metrics of the at least one MVP set, and identify at least one best Rx beam from the first set of narrower Rx beams, the at least one best Rx beam being associated with best estimated metrics. A ML training server may obtain at least one coefficient of the ML model, and the at least one coefficient of the ML model may be sent to the UE 1102. The UE 1102 may configure the ML model for estimating the metric of the set of narrower Rx beams. The UE 1102 may transmit at least a part of the metrics of the subset of PO beams or estimated metrics of the set of Rx beams to the ML model training server, and the ML model training server may obtain the at least one coefficient of the ML modem based on the at least a part of the metrics of the subset of PO beams or the estimated metrics of the set of Rx beams received from the UE 1102.

At 1108, the first network node 1104 may transmit a signal on a plurality of PO beams. The UE 1102 may receive the signal on the plurality of PO beams. The signal may include an SSB or a reference signal such as a CSI-RS. The plurality of PO beams may include at least one subset of PO beams, each subset of PO beams configured to form a PO pattern. Here, each PO beam may be associated with a set of narrower Rx beams of the UE 1102.

At 1110, the UE 1102 may initiate a timer prior to measuring metrics of the first subset of PO beams at 1112. Here, the metrics of the first set of Rx beams may be estimated at 1124 based on an expiration of the timer. Here, the timer may be a beam selection timer. The UE 1102 may be configured to initiate the timer and upon expiration of the timer, the UE 1102 may stop the measurement of the metrics of the subset of PO beams at 1112 and start estimating metrics of the set of narrower Rx beams using the ML model at 1116.

At 1112, the UE 1102 may measure metrics of a subset of PO beams of at least one subset of PO beams including a plurality of PO beams received from the network node at 1108. Here, the subset of PO beams may refer to an MVP set including PO beams configured to form a PO pattern and the first subset of PO beams being associated with a first set of narrower RX beams of the UE 1102.

In one aspect, the subset of PO beams may include a first subset of PO beams, and the first set of narrower Rx beams estimated using the ML model at 1124 may be estimated based on the metrics of the first subset of PO beams. The UE 1102 may stop the measurement of the subset of PO beams and estimation of the narrower Rx beams based on the estimated metric of the narrower Rx beams being greater than a threshold value. (e.g., a first threshold value).

In another aspect, based on the metric of the narrower Rx beams estimated based on the first subset of PO beams being smaller than or equal to the first threshold value, the UE 1102 may measure a second subset of PO beams, and a second set of narrower Rx beams may be estimated using the ML model at 1124 based on the metrics of the first subset of PO beams and the second subset of PO beams.

At 1114, the second network node 1105 may transmit a signal, e.g., similar to 1108, on another set of plurality of PO beams including a third subset of PO beams to the UE 1102. The UE 1102 may receive the another set of plurality of PO beams including the third subset of PO beams from the second network node 1105. Here, the second network node 1105 may be associated with a neighboring cell.

At 1116, the UE 1102 may measure metrics of the third subset of PO beams from a neighboring network node, and the third subset of PO beams may be associated with a third set of Rx beams. Here, based on the metrics of the third subset of PO beams received, the UE 1102 may use the ML model to estimate the third set of narrower Rx beams at 1124, based on the metrics of the third subset of PO being greater than the metrics of the first subset of PO beams by a second threshold value.

At 1120, the ML training server 1106 may obtain at least one coefficient of the ML model for estimating a set of RX beams based on metrics of a subset of PO beams. The at least one coefficient of the ML model may be obtained based on the at least a part of metrics of the subset of PO beams or estimated metrics of a set of Rx beams received from the UE 1102. (e.g., at 1126). That is, the ML training server 1106 may train the ML model using the at least a part of the metrics of the subset of PO beams or the estimated metrics of the set of Rx beams received from the UE 1102, and generate at least one coefficient of the ML model for the UE 1102.

At 1122, the ML training server 1106 may transmit the at least one coefficient associated with the ML model for the UE 1102 to estimate the metrics of the set of Rx beams using the ML model based on the at least one coefficient and metrics of a subset of PO beams. The UE 1102 may receive at least one coefficient associated with the ML model, the metrics of the set of Rx beams may be estimated using the ML model at 1124 based on the at least one coefficient and the metrics of the subset of PO beams (e.g., the first subset of PO beams or the second subset of PO beams received from the first network node 1104 at 1108 or the third subset of PO beams received from the second network node 1105 at 1114). Here, the at least one coefficient received from the ML model training server may be based at least one the at least a part of the metrics of the first subset of PO beams or estimated metrics of the first set of Rx beams.

At 1124, the UE 1102 may estimate metrics of a set of narrower Rx beams using ML model based on the metrics of the subset of PO beams. Here, the metrics of the Rx beams may be estimated at every estimation periodicity, each estimation periodicity including measuring of metrics of at least one subset of PO beams and the searching of the at least one Rx beam. The UE 1102 may estimate the metrics of the first set of Rx beams using the ML model based on at least one coefficient received at 1122 from the ML training server 1106.

In one example, the set of narrower Rx beams may be a first set of narrower Rx beams estimated using the ML model based on the metrics of the first subset of PO beams measured at 1112. In another example, the set of narrower Rx beams may be second set of narrower Rx beams estimated using the ML model based on the metrics of the first subset of PO beams and the second subset of PO beams measured at 1112.

In another example, the set of narrower Rx beams may be a third set of narrower Rx beams estimated using the ML model based on the metrics of the third subset of PO beams received at 1114, based on the metrics of the third subset of PO being greater than the metrics of the first subset of PO beams by a second threshold value.

At 1126, the UE 1102 may transmit at least a part of the metrics of the subset of PO beams or estimated metrics of the set of Rx beams to the ML model training server. The ML training server 1106 may receive at least a part of metrics of a subset of PO beams or estimated metrics of a set of Rx beams from the UE 1102. The at least one coefficient of the ML model may be obtained at 1120 based on the at least a part of metrics of the subset of PO beams or estimated metrics of a set of Rx beams received from the UE 1102.

In one example, the metrics of the subset of PO beams may be the first subset of PO beams, and the set of narrower Rx beams may include the first set of narrower Rx beams estimated using the ML model at 1124 based on the metrics of the first subset of PO beams. In another example, the metrics of the subset of PO beams may be the first subset of PO beams and the second subset of PO beams, and the set of narrower Rx beams may include the second set of narrower Rx beams estimated using the ML model at 1124 based on the metrics of the first subset of PO beams and the second subset of PO beams. In another example, the metrics of the subset of PO beams may be the third subset of PO beams received from the second network node 1105 at 1114, and the set of narrower Rx beams may include the third set of narrower Rx beams estimated using the ML model at 1124 based on the metrics of the third subset of PO beams.

At 1128, the UE 1102 may identify at least one best Rx beam from the set of narrower Rx beams, the at least one best Rx beam being associated with best estimated metrics among the first set of narrower Rx beams. In one example, the set of narrower Rx beams may be a first set of narrower Rx beams estimated using the ML model based on the metrics of the first subset of PO beams measured at 1112. In another example, the set of narrower Rx beams may be second set of narrower Rx beams estimated using the ML model based on the metrics of the first subset of PO beams and the second subset of PO beams measured at 1112. In another example, the set of narrower Rx beams may include the third set of narrower Rx beams estimated using the ML model at 1124 based on the metrics of the third subset of PO beams measured at 1116.

At 1130, the UE 1102 may report the metrics of the subset of PO beams to the network node based on the estimated metrics of the at least one Rx beam being greater than a first threshold value. In one example, the metrics of the subset of PO beams may be the first subset of PO beams based on the estimated metric of the first set of narrower Rx beams being greater than the first threshold value. In another example, the metrics of the subset of PO beams may be the first subset of PO beams and the second subset of PO beams based on the second set of narrower Rx beams being greater than the first threshold value. In another example, the metrics of the subset of PO beams may be the third subset of PO beams received from the second network node 1105 at 1114 based on based on the metrics of the third subset of PO being greater than the metrics of the first subset of PO beams by the second threshold value.

At 1132, the UE 1102 may search for the at least one best Rx beam associated with the best estimated metrics among the set of Rx beams.

At 1134, the UE 1102 may perform data communication using the at least one best Rx beam with the network node based on the estimated metrics of the at least one best Rx beam being greater than a first threshold value. Here, the UE 1102 may use the refined Rx beam estimated based on the metrics of at least one MVP set using the ML model. Here, the UE 1102 may use the narrower Rx beam (e.g., the L3 beam) without reporting the L3 beam to the network node at 1130.

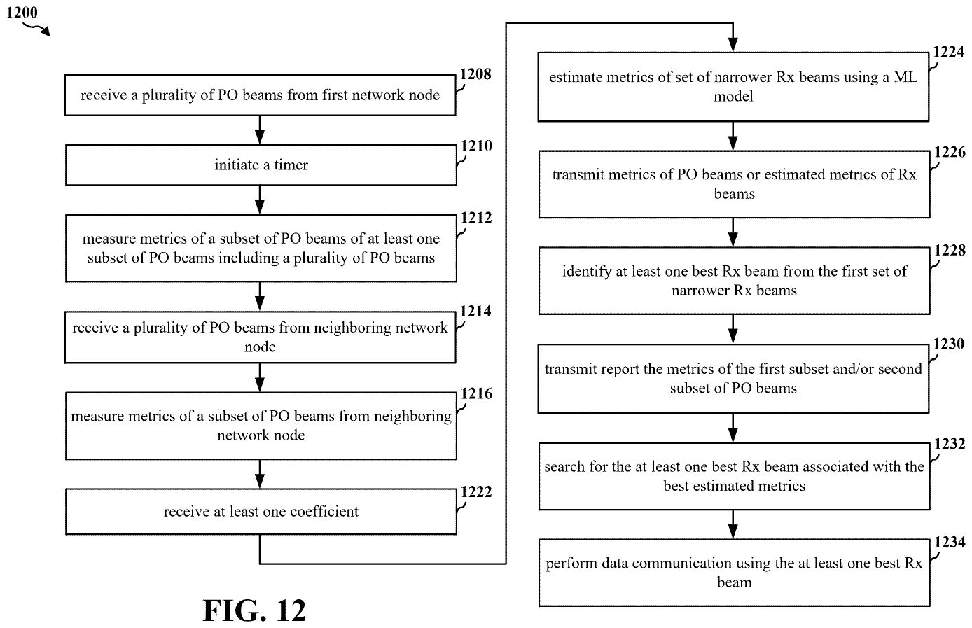

FIG. 12 is a flowchart 1200 of a method of wireless communication. The method may be performed by a UE (e.g., the UE 104; the apparatus 1604). The UE may measure metrics of at least one MVP set (e.g., including the L1 beams) from a network node (e.g., the serving network node or neighboring network nodes), estimate metrics of a set of narrower Rx beams (e.g., the L3 beams) using a ML model based on the metrics of the at least one MVP set, and identify at least one best Rx beam from the first set of narrower Rx beams, the at least one best Rx beam being associated with best estimated metrics. The UE may receive at least one coefficient of the ML model from a ML training server, and configure the ML model for estimating the metric of the set of narrower Rx beams. The UE may transmit at least a part of the metrics of the subset of PO beams or estimated metrics of the set of Rx beams for the ML model training server to obtain the at least one coefficient of the ML modem.

At 1208, the UE may receive the plurality of PO beams. The plurality of PO beams may include at least one subset of PO beams, each subset of PO beams configured to form a PO pattern. Here, each PO beam may be associated with a set of narrower Rx beams of the UE. For example, at 1108, the UE 1102 may receive the plurality of PO beams. Furthermore, 1208 may be performed by the L3 beam estimation component 198.

At 1210, the UE may initiate a timer prior to measuring metrics of the first subset of PO beams at 1212. Here, the metrics of the first set of Rx beams may be estimated at 1224 based on an expiration of the timer. Here, the timer may be a beam selection timer. The UE may be configured to initiate the timer and upon expiration of the timer, the UE may stop the measurement of the metrics of the subset of PO beams at 1212 and start estimating metrics of the set of narrower Rx beams using the ML model at 1216. For example, at 1110, the UE 1102 may initiate a timer prior to measuring metrics of the first subset of PO beams at 1112. Furthermore, 1210 may be performed by the L3 beam estimation component 198.

At 1212, the UE may measure metrics of a subset of PO beams of at least one subset of PO beams including a plurality of PO beams received from the network node at 1208. Here, the subset of PO beams may refer to an MVP set including PO beams configured to form a PO pattern and the first subset of PO beams being associated with a first set of narrower RX beams of the UE. For example, at 1112, the UE 1102 may measure metrics of a subset of PO beams of at least one subset of PO beams including a plurality of PO beams received from the network node at 1108. Furthermore, 1212 may be performed by the L3 beam estimation component 198.

In one aspect, the subset of PO beams may include a first subset of PO beams, and the first set of narrower Rx beams estimated using the ML model at 1224 may be estimated based on the metrics of the first subset of PO beams. The UE may stop the measurement of the subset of PO beams and estimation of the narrower Rx beams based on the estimated metric of the narrower Rx beams being greater than a threshold value. (e.g., a first threshold value).

In another aspect, based on the metric of the narrower Rx beams estimated based on the first subset of PO beams being smaller than or equal to the first threshold value, the UE may measure a second subset of PO beams, and a second set of narrower Rx beams may be estimated using the ML model at 1224 based on the metrics of the first subset of PO beams and the second subset of PO beams.

At 1214, the UE may receive the another set of plurality of PO beams including the third subset of PO beams from the second network node. Here, the second network node may be associated with a neighboring cell. For example, at 1114, the UE 1102 may receive the another set of plurality of PO beams including the third subset of PO beams from the second network node 1105. Furthermore, 1214 may be performed by the L3 beam estimation component 198.

At 1216, the UE may measure metrics of the third subset of PO beams from a neighboring network node, and the third subset of PO beams may be associated with a third set of Rx beams. Here, based on the metrics of the third subset of PO beams received, the UE may use the ML model to estimate the third set of narrower Rx beams at 1224, based on the metrics of the third subset of PO being greater than the metrics of the first subset of PO beams by a second threshold value. For example, at 1116, the UE 1102 may measure metrics of the third subset of PO beams from a neighboring network node, and the third subset of PO beams may be associated with a third set of Rx beams. Furthermore, 1216 may be performed by an L3 beam estimation component 198.

At 1222, the UE may receive at least one coefficient associated with the ML model, the metrics of the set of Rx beams may be estimated using the ML model at 1224 based on the at least one coefficient and the metrics of the subset of PO beams. Here, the subset of PO beams may include the first subset of PO beams or the second subset of PO beams received from the first network node at 1208 or the third subset of PO beams received from the second network node at 1214. The at least one coefficient received from the ML model training server may be based at least one the at least a part of the metrics of the first subset of PO beams or estimated metrics of the first set of Rx beams. For example, at 1122, the UE 1102 may receive at least one coefficient associated with the ML model, the metrics of the set of Rx beams may be estimated using the ML model at 1124 based on the at least one coefficient and the metrics of the subset of PO beams. Furthermore, 1222 may be performed by the L3 beam estimation component 198.

At 1224, the UE may estimate metrics of a set of narrower Rx beams using ML model based on the metrics of the subset of PO beams. Here, the metrics of the Rx beams may be estimated at every estimation periodicity, each estimation periodicity including measuring of metrics of at least one subset of PO beams and the searching of the at least one Rx beam. The UE may estimate the metrics of the first set of Rx beams using the ML model based on at least one coefficient received at 1222 from the ML training server. For example, at 1124, the UE 1102 may estimate metrics of a set of narrower Rx beams using ML model based on the metrics of the subset of PO beams. Furthermore, 1224 may be performed by the L3 beam estimation component 198.

In one example, the set of narrower Rx beams may be a first set of narrower Rx beams estimated using the ML model based on the metrics of the first subset of PO beams measured at 1212. In another example, the set of narrower Rx beams may be second set of narrower Rx beams estimated using the ML model based on the metrics of the first subset of PO beams and the second subset of PO beams measured at 1212.

In another example, the set of narrower Rx beams may be a third set of narrower Rx beams estimated using the ML model based on the metrics of the third subset of PO beams received at 1214, based on the metrics of the third subset of PO being greater than the metrics of the first subset of PO beams by a second threshold value.

At 1226, the UE may transmit at least a part of the metrics of the subset of PO beams or estimated metrics of the set of Rx beams to the ML model training server. The ML training server may receive at least a part of metrics of a subset of PO beams or estimated metrics of a set of Rx beams from the UE. The at least one coefficient of the ML model may be obtained at 1220 based on the at least a part of metrics of the subset of PO beams or estimated metrics of a set of Rx beams received from the UE. For example, at 1126, the UE 1102 may transmit at least a part of the metrics of the subset of PO beams or estimated metrics of the set of Rx beams to the ML model training server. Furthermore, 1226 may be performed by an L3 beam estimation component 198.

In one example, the metrics of the subset of PO beams may be the first subset of PO beams, and the set of narrower Rx beams may include the first set of narrower Rx beams estimated using the ML model at 1224 based on the metrics of the first subset of PO beams. In another example, the metrics of the subset of PO beams may be the first subset of PO beams and the second subset of PO beams, and the set of narrower Rx beams may include the second set of narrower Rx beams estimated using the ML model at 1224 based on the metrics of the first subset of PO beams and the second subset of PO beams. In another example, the metrics of the subset of PO beams may be the third subset of PO beams received from the second network node at 1214, and the set of narrower Rx beams may include the third set of narrower Rx beams estimated using the ML model at 1224 based on the metrics of the third subset of PO beams.

At 1228, the UE may identify at least one best Rx beam from the set of narrower Rx beams, the at least one best Rx beam being associated with best estimated metrics among the first set of narrower Rx beams. In one example, the set of narrower Rx beams may be a first set of narrower Rx beams estimated using the ML model based on the metrics of the first subset of PO beams measured at 1212. In another example, the set of narrower Rx beams may be second set of narrower Rx beams estimated using the ML model based on the metrics of the first subset of PO beams and the second subset of PO beams measured at 1212. In another example, the set of narrower Rx beams may include the third set of narrower Rx beams estimated using the ML model at 1224 based on the metrics of the third subset of PO beams measured at 1216. For example, at 1128, the UE 1102 may identify at least one best Rx beam from the set of narrower Rx beams, the at least one best Rx beam being associated with best estimated metrics among the first set of narrower Rx beams. Furthermore, 1228 may be performed by the L3 beam estimation component 198.

At 1230, the UE may report the metrics of the subset of PO beams to the network node based on the estimated metrics of the at least one Rx beam being greater than a first threshold value. In one example, the metrics of the subset of PO beams may be the first subset of PO beams based on the estimated metric of the first set of narrower Rx beams being greater than the first threshold value. In another example, the metrics of the subset of PO beams may be the first subset of PO beams and the second subset of PO beams based on the second set of narrower Rx beams being greater than the first threshold value. In another example, the metrics of the subset of PO beams may be the third subset of PO beams received from the second network node at 1214 based on based on the metrics of the third subset of PO being greater than the metrics of the first subset of PO beams by the second threshold value. For example, at 1130, the UE 1102 may report the metrics of the subset of PO beams to the network node based on the estimated metrics of the at least one Rx beam being greater than a first threshold value. Furthermore, 1230 may be performed by the L3 beam estimation component 198.

At 1232, the UE may search for the at least one best Rx beam associated with the best estimated metrics among the set of Rx beams. For example, at 1132, the UE 1102 may search for the at least one best Rx beam associated with the best estimated metrics among the set of Rx beams. Furthermore, 1232 may be performed by the L3 beam estimation component 198.

At 1234, the UE may perform data communication using the at least one best Rx beam with the network node based on the estimated metrics of the at least one best Rx beam being greater than a first threshold value. Here, the UE may use the refined Rx beam estimated based on the metrics of at least one MVP set using the ML model. Here, the UE may use the narrower Rx beam (e.g., the L3 beam) without reporting the L3 beam to the network node at 1230. For example, at 1134, the UE 1102 may perform data communication using the at least one best Rx beam with the network node based on the estimated metrics of the at least one best Rx beam being greater than a first threshold value. Furthermore, 1234 may be performed by the L3 beam estimation component 198.

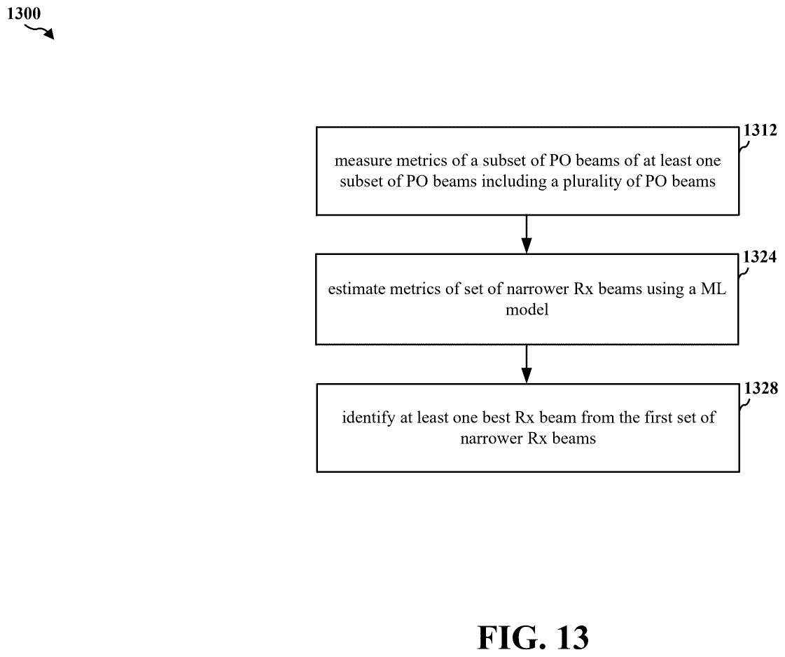

FIG. 13 is a flowchart 1300 of a method of wireless communication. The method may be performed by a UE (e.g., the UE 104; the apparatus 1604). The UE may measure metrics of at least one MVP set (e.g., including the L1 beams) from a network node (e.g., the serving network node or neighboring network nodes), estimate metrics of a set of narrower Rx beams (e.g., the L3 beams) using a ML model based on the metrics of the at least one MVP set, and identify at least one best Rx beam from the first set of narrower Rx beams, the at least one best Rx beam being associated with best estimated metrics. The UE may receive at least one coefficient of the ML model from a ML training server, and configure the ML model for estimating the metric of the set of narrower Rx beams. The UE may transmit at least a part of the metrics of the subset of PO beams or estimated metrics of the set of Rx beams for the ML model training server to obtain the at least one coefficient of the ML modem.

At 1312, the UE may measure metrics of a subset of PO beams of at least one subset of PO beams including a plurality of PO beams received from the network node. Here, the subset of PO beams may refer to an MVP set including PO beams configured to form a PO pattern and the first subset of PO beams being associated with a first set of narrower RX beams of the UE. For example, at 1112, the UE 1102 may measure metrics of a subset of PO beams of at least one subset of PO beams including a plurality of PO beams received from the network node at 1108. Furthermore, 1312 may be performed by the L3 beam estimation component 198.

In one aspect, the subset of PO beams may include a first subset of PO beams, and the first set of narrower Rx beams estimated using the ML model at 1324 may be estimated based on the metrics of the first subset of PO beams. The UE may stop the measurement of the subset of PO beams and estimation of the narrower Rx beams based on the estimated metric of the narrower Rx beams being greater than a threshold value. (e.g., a first threshold value).

In another aspect, based on the metric of the narrower Rx beams estimated based on the first subset of PO beams being smaller than or equal to the first threshold value, the UE may measure a second subset of PO beams, and a second set of narrower Rx beams may be estimated using the ML model at 1324 based on the metrics of the first subset of PO beams and the second subset of PO beams.

At 1324, the UE may estimate metrics of a set of narrower Rx beams using ML model based on the metrics of the subset of PO beams. Here, the metrics of the Rx beams may be estimated at every estimation periodicity, each estimation periodicity including measuring of metrics of at least one subset of PO beams and the searching of the at least one Rx beam. The UE may estimate the metrics of the first set of Rx beams using the ML model based on at least one coefficient received from the ML training server. For example, at 1124, the UE 1102 may estimate metrics of a set of narrower Rx beams using ML model based on the metrics of the subset of PO beams. Furthermore, 1324 may be performed by the L3 beam estimation component 198.

In one example, the set of narrower Rx beams may be a first set of narrower Rx beams estimated using the ML model based on the metrics of the first subset of PO beams measured at 1312. In another example, the set of narrower Rx beams may be second set of narrower Rx beams estimated using the ML model based on the metrics of the first subset of PO beams and the second subset of PO beams measured at 1312.

In another example, the set of narrower Rx beams may be a third set of narrower Rx beams estimated using the ML model based on the metrics of the third subset of PO beams received, based on the metrics of the third subset of PO being greater than the metrics of the first subset of PO beams by a second threshold value.

At 1328, the UE may identify at least one best Rx beam from the set of narrower Rx beams, the at least one best Rx beam being associated with best estimated metrics among the first set of narrower Rx beams. In one example, the set of narrower Rx beams may be a first set of narrower Rx beams estimated using the ML model based on the metrics of the first subset of PO beams measured at 1312. In another example, the set of narrower Rx beams may be second set of narrower Rx beams estimated using the ML model based on the metrics of the first subset of PO beams and the second subset of PO beams measured at 1312. In another example, the set of narrower Rx beams may include the third set of narrower Rx beams estimated using the ML model at 1324 based on the metrics of the third subset of PO beams measured. For example, at 1128, the UE 1102 may identify at least one best Rx beam from the set of narrower Rx beams, the at least one best Rx beam being associated with best estimated metrics among the first set of narrower Rx beams. Furthermore, 1328 may be performed by the L3 beam estimation component 198.

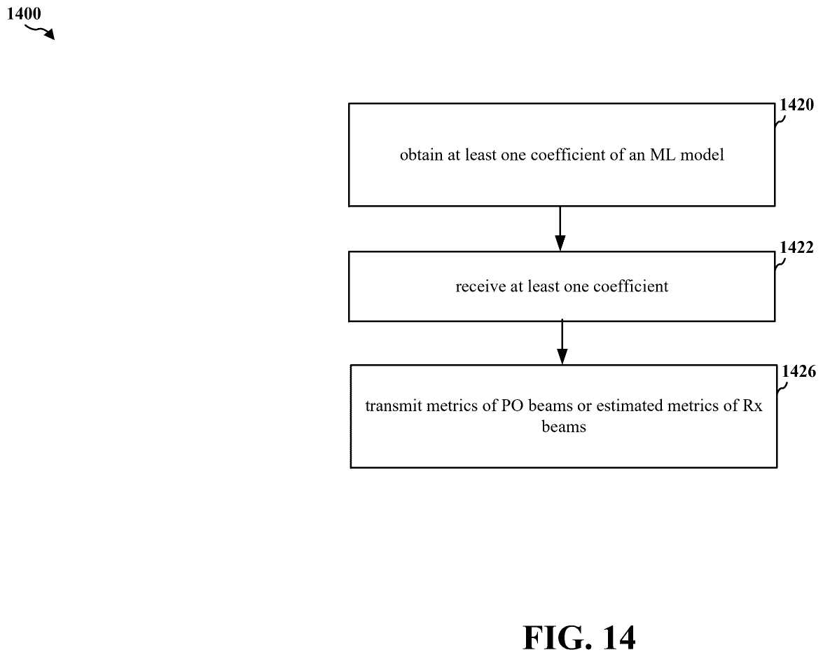

FIG. 14 is a flowchart 1400 of a method of wireless communication. The method may be performed by a network entity (e.g., the ML training server 1106; the apparatus 1704). Here, the network entity may be a ML training server. The ML training server may obtain at least one coefficient of the ML model, and the at least one coefficient of the ML model may be sent to the UE. The UE may configure the ML model for estimating the metric of the set of narrower Rx beams. The network entity may receive at least a part of the metrics of the subset of PO beams or estimated metrics of the set of Rx beams from the UE, and the ML model training server may obtain the at least one coefficient of the ML modem based on the at least a part of the metrics of the subset of PO beams or the estimated metrics of the set of Rx beams received from the UE.

At 1420, the network entity may obtain at least one coefficient of the ML model for estimating a set of RX beams based on metrics of a subset of PO beams. The at least one coefficient of the ML model may be obtained based on the at least a part of metrics of the subset of PO beams or estimated metrics of a set of Rx beams received from the UE. (e.g., at 1426). That is, the ML training server may train the ML model using the at least a part of the metrics of the subset of PO beams or the estimated metrics of the set of Rx beams received from the UE, and generate at least one coefficient of the ML model for the UE. For example, at 1120, the network entity 1120 may obtain at least one coefficient of the ML model for estimating a set of RX beams based on metrics of a subset of PO beams. Furthermore, 1420 may be performed by an ML model training component 199.

At 1422, the network entity may transmit the at least one coefficient associated with the ML model for the UE to estimate the metrics of the set of Rx beams using the ML model based on the at least one coefficient and metrics of a subset of PO beams. The subset of PO beams may include the first subset of PO beams or the second subset of PO beams received from the first network node or the third subset of PO beams received from the second network node. Here, the at least one coefficient received from the ML model training server may be based at least one the at least a part of the metrics of the first subset of PO beams or estimated metrics of the first set of Rx beams. For example, at 1122, the ML training server 1106 may transmit the at least one coefficient associated with the ML model for the UE 1102 to estimate the metrics of the set of Rx beams using the ML model based on the at least one coefficient and metrics of a subset of PO beams. Furthermore, 1422 may be performed by the ML model training component 199.

At 1426, the network entity may receive at least a part of metrics of a subset of PO beams or estimated metrics of a set of Rx beams from the UE. The at least one coefficient of the ML model may be obtained at 1420 based on the at least a part of metrics of the subset of PO beams or estimated metrics of a set of Rx beams received from the UE. For example, at 1126, the ML training server 1106 may receive at least a part of metrics of a subset of PO beams or estimated metrics of a set of Rx beams from the UE 1102. Furthermore, 1426 may be performed by the ML model training component 199.

In one example, the metrics of the subset of PO beams may be the first subset of PO beams, and the set of narrower Rx beams may include the first set of narrower Rx beams estimated using the ML model based on the metrics of the first subset of PO beams. In another example, the metrics of the subset of PO beams may be the first subset of PO beams and the second subset of PO beams, and the set of narrower Rx beams may include the second set of narrower Rx beams estimated using the ML model based on the metrics of the first subset of PO beams and the second subset of PO beams. In another example, the metrics of the subset of PO beams may be the third subset of PO beams received from the second network node, and the set of narrower Rx beams may include the third set of narrower Rx beams estimated using the ML model based on the metrics of the third subset of PO beams.

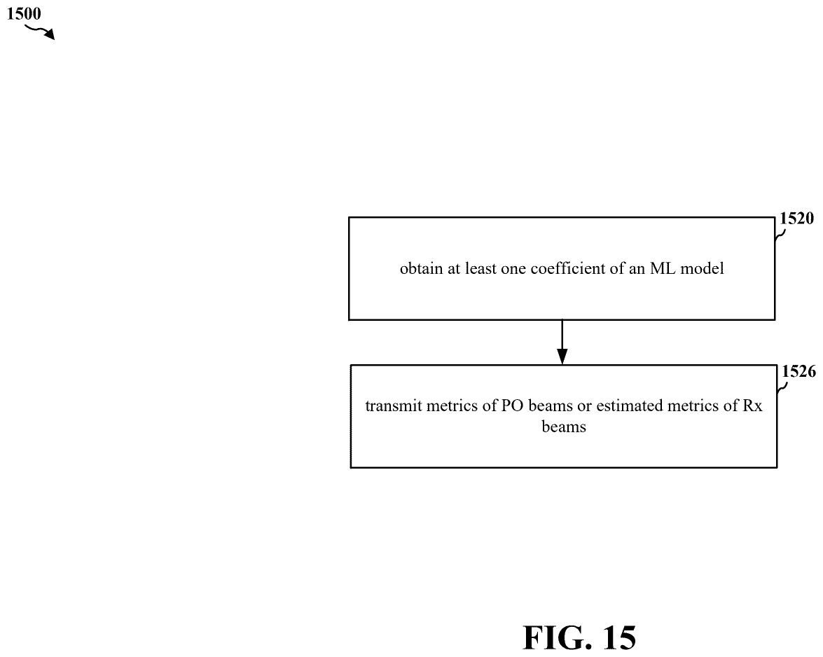

FIG. 15 is a flowchart 1500 of a method of wireless communication. The method may be performed by a network entity (e.g., the ML training server 1106; the apparatus 1704). Here, the network entity may be a ML training server. The ML training server may obtain at least one coefficient of the ML model, and the at least one coefficient of the ML model may be sent to the UE. The UE may configure the ML model for estimating the metric of the set of narrower Rx beams. The network entity may receive at least a part of the metrics of the subset of PO beams or estimated metrics of the set of Rx beams from the UE, and the ML model training server may obtain the at least one coefficient of the ML modem based on the at least a part of the metrics of the subset of PO beams or the estimated metrics of the set of Rx beams received from the UE.

At 1520, the network entity may obtain at least one coefficient of the ML model for estimating a set of RX beams based on metrics of a subset of PO beams. The at least one coefficient of the ML model may be obtained based on the at least a part of metrics of the subset of PO beams or estimated metrics of a set of Rx beams received from the UE. (e.g., at 1526). That is, the ML training server may train the ML model using the at least a part of the metrics of the subset of PO beams or the estimated metrics of the set of Rx beams received from the UE, and generate at least one coefficient of the ML model for the UE. For example, at 1120, the network entity 1120 may obtain at least one coefficient of the ML model for estimating a set of RX beams based on metrics of a subset of PO beams. Furthermore, 1520 may be performed by an ML model training component 199.

At 1526, the network entity may receive at least a part of metrics of a subset of PO beams or estimated metrics of a set of Rx beams from the UE. The at least one coefficient of the ML model may be obtained at 1520 based on the at least a part of metrics of the subset of PO beams or estimated metrics of a set of Rx beams received from the UE. For example, at 1126, the ML training server 1106 may receive at least a part of metrics of a subset of PO beams or estimated metrics of a set of Rx beams from the UE 1102. Furthermore, 1526 may be performed by the ML model training component 199.

In one example, the metrics of the subset of PO beams may be the first subset of PO beams, and the set of narrower Rx beams may include the first set of narrower Rx beams estimated using the ML model based on the metrics of the first subset of PO beams. In another example, the metrics of the subset of PO beams may be the first subset of PO beams and the second subset of PO beams, and the set of narrower Rx beams may include the second set of narrower Rx beams estimated using the ML model based on the metrics of the first subset of PO beams and the second subset of PO beams. In another example, the metrics of the subset of PO beams may be the third subset of PO beams received from the second network node, and the set of narrower Rx beams may include the third set of narrower Rx beams estimated using the ML model based on the metrics of the third subset of PO beams.

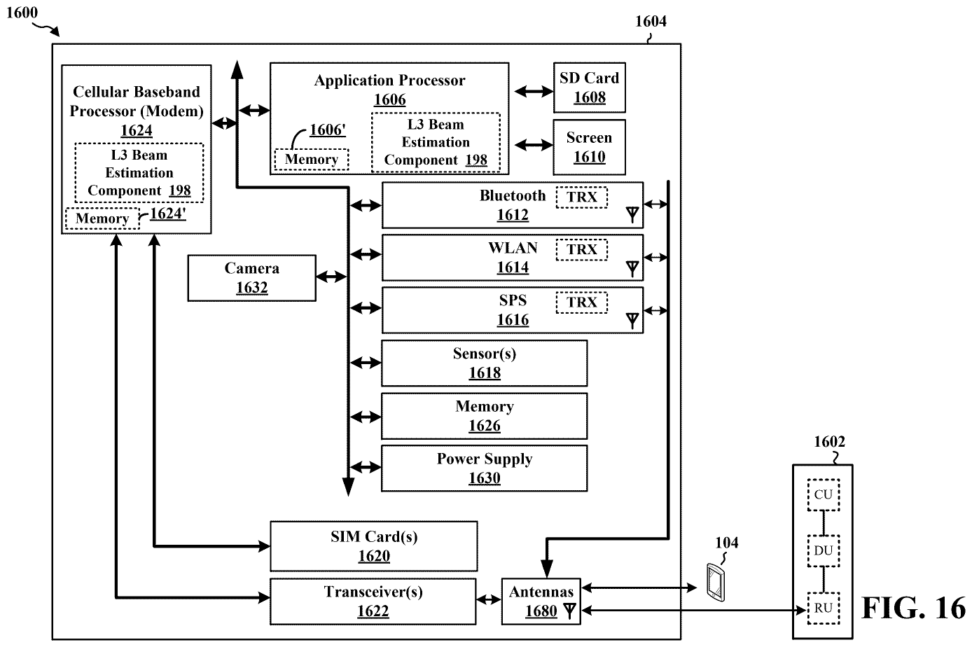

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include a cellular baseband processor 1624 (also referred to as a modem) coupled to one or more transceivers 1622 (e.g., cellular RF transceiver). The cellular baseband processor 1624 may include on-chip memory 1624′. In some aspects, the apparatus 1604 may further include one or more subscriber identity modules (SIM) cards 1620 and an application processor 1606 coupled to a secure digital (SD) card 1608 and a screen 1610. The application processor 1606 may include on-chip memory 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor 1624 communicates through the transceiver(s) 1622 via one or more antennas 1680 with the UE 104 and/or with an RU associated with a network entity 1602. The cellular baseband processor 1624 and the application processor 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor 1624 and the application processor 1606 are each responsible for general processing, including the execution of software stored on the computer-readable medium/memory. The software, when executed by the cellular baseband processor 1624/application processor 1606, causes the cellular baseband processor 1624/application processor 1606 to perform the various functions described supra. The computer-readable medium/memory may also be used for storing data that is manipulated by the cellular baseband processor 1624/application processor 1606 when executing software. The cellular baseband processor 1624/application processor 1606 may be a component of the UE 350 and may include the memory 360 and/or at least one of the TX processor 368, the RX processor 356, and the controller/processor 359. In one configuration, the apparatus 1604 may be a processor chip (modem and/or application) and include just the cellular baseband processor 1624 and/or the application processor 1606, and in another configuration, the apparatus 1604 may be the entire UE (e.g., see 350 of FIG. 3) and include the additional modules of the apparatus 1604.

As discussed supra, the component 198 is configured to measure metrics of a first subset of PO beams of at least one subset of PO beams including a plurality of PO beams from a network node, each subset of PO beams configured to form a PO pattern and the first subset of PO beams being associated with a first set of narrower RX beams of the UE, estimate metrics of the first set of narrower Rx beams using a ML model based on the metrics of the subset of PO beams, and identify at least one best Rx beam from the first set of narrower Rx beams, the at least one best Rx beam being associated with best estimated metrics among the first set of narrower Rx beams. The component 198 may be within the cellular baseband processor 1624, the application processor 1606, or both the cellular baseband processor 1624 and the application processor 1606. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1604 may include a variety of components configured for various functions. In one configuration, the apparatus 1604, and in particular the cellular baseband processor 1624 and/or the application processor 1606, includes means for measuring metrics of a first subset of PO beams of at least one subset of PO beams including a plurality of PO beams from a network node, each subset of PO beams configured to form a PO pattern and the first subset of PO beams being associated with a first set of narrower RX beams of the UE, means for estimating metrics of the first set of narrower Rx beams using a ML model based on the metrics of the subset of PO beams, and means for identifying at least one best Rx beam from the first set of narrower Rx beams, the at least one best Rx beam being associated with best estimated metrics among the first set of narrower Rx beams. In one configuration, the apparatus 1604, and in particular the cellular baseband processor 1624 and/or the application processor 1606, further includes means for performing data communication using the at least one best Rx beam with the network node based on the estimated metrics of the at least one best Rx beam being greater than a first threshold value. In one configuration, the apparatus 1604, and in particular the cellular baseband processor 1624 and/or the application processor 1606, further includes means for reporting the metrics of the first subset of PO beams to the network node based on the estimated metrics of the at least one Rx beam being greater than a first threshold value. In one configuration, the apparatus 1604, and in particular the cellular baseband processor 1624 and/or the application processor 1606, further includes means for estimating metrics of a second subset of PO beams of the at least one subset of PO beams based on the estimated metrics of the at least one best Rx beam being smaller than or equal to a first threshold value, the first subset of PO beams being associated with a second set of RX beams. In one configuration, the apparatus 1604, and in particular the cellular baseband processor 1624 and/or the application processor 1606, further includes means for identifying at least one best Rx beam from the second set of Rx beams, the at least one best Rx beam being associated with best estimated metrics among the second set of Rx beams. In one configuration, the apparatus 1604, and in particular the cellular baseband processor 1624 and/or the application processor 1606, further includes means for reporting the metrics of the first subset of PO beams and the second subset of PO beams to the network node based on the estimated metric of the second best Rx beam being greater than the first threshold value. In one configuration, the apparatus 1604, and in particular the cellular baseband processor 1624 and/or the application processor 1606, further includes means for searching for the at least one best Rx beam associated with the best estimated metrics among the first set of Rx beams. In one configuration, the metrics of the Rx beams are estimated at every estimation periodicity, each estimation periodicity including measuring of metrics of at least one subset of PO beams and the searching of the at least one Rx beam. In one configuration, the apparatus 1604, and in particular the cellular baseband processor 1624 and/or the application processor 1606, further includes means for initiating a timer prior to measuring metrics of the first subset of PO beams, where the metrics of the first set of Rx beams are estimated based on an expiration of the timer. In one configuration, the apparatus 1604, and in particular the cellular baseband processor 1624 and/or the application processor 1606, further includes means for measuring metrics of a third subset of PO beams from a neighboring network node, the third subset of PO beams being associated with a third set of Rx beams, and means for estimating metrics of the third set of Rx beams using the ML model based on the metrics of the third subset of PO beams being greater than the metrics of the first subset of PO beams by a second threshold value. In one configuration, the metrics of the first set of Rx beams are estimated using the ML model based on at least one coefficient and the metrics of the subset of PO beams. In one configuration, the apparatus 1604, and in particular the cellular baseband processor 1624 and/or the application processor 1606, further includes means for receiving at least one coefficient associated with the ML model, the metrics of the first set of Rx beams being estimated using the ML model based on the at least one coefficient and the metrics of the subset of PO beams. In one configuration, the apparatus 1604, and in particular the cellular baseband processor 1624 and/or the application processor 1606, further includes means for transmitting at least a part of the metrics of the first subset of PO beams or estimated metrics of the first set of Rx beams to an ML model training server, where the at least one coefficient received from the ML model training server is based at least one the at least a part of the metrics of the first subset of PO beams or estimated metrics of the first set of Rx beams. The means may be the component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

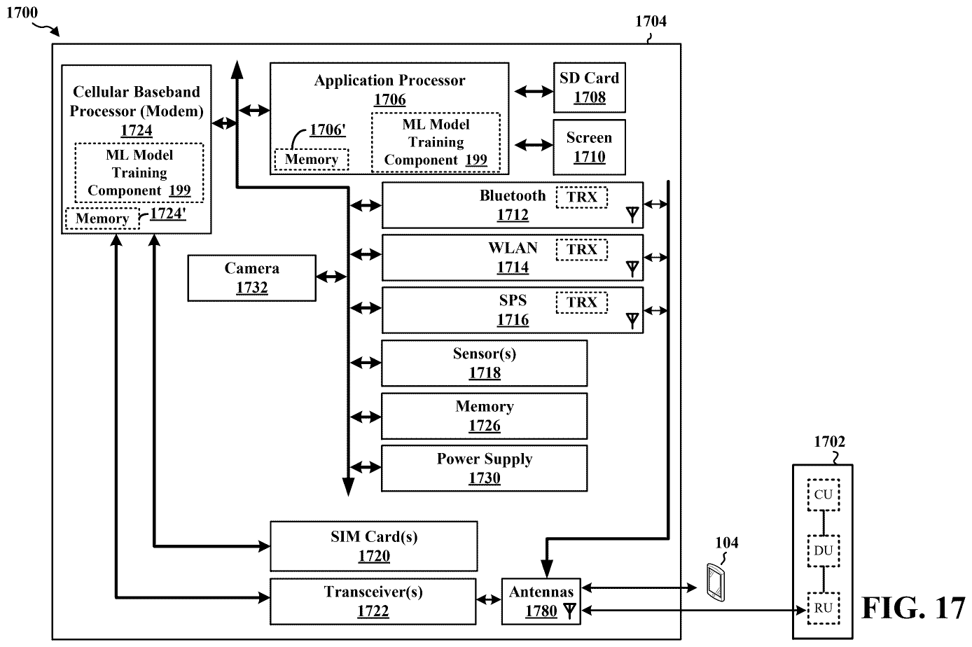

FIG. 17 is a diagram 1700 illustrating an example of a hardware implementation for an apparatus 1704. The apparatus 1704 may be a server for ML training, a component of a server, or may implement server functionality. In some aspects, the apparatus 1604 may include a cellular baseband processor 1724 (also referred to as a modem) coupled to one or more transceivers 1722 (e.g., cellular RF transceiver). The cellular baseband processor 1724 may include on-chip memory 1724′. In some aspects, the apparatus 1704 may further include one or more subscriber identity modules (SIM) cards 1720 and an application processor 1706 coupled to a secure digital (SD) card 1708 and a screen 1710. The application processor 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor 1724 communicates through the transceiver(s) 1722 via one or more antennas 1780 with the UE 104 and/or with an RU associated with a network entity 1702. The cellular baseband processor 1724 and the application processor 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor 1724 and the application processor 1706 are each responsible for general processing, including the execution of software stored on the computer-readable medium/memory. The software, when executed by the cellular baseband processor 1724/application processor 1706, causes the cellular baseband processor 1724/application processor 1706 to perform the various functions described supra. The computer-readable medium/memory may also be used for storing data that is manipulated by the cellular baseband processor 1724/application processor 1706 when executing software. The cellular baseband processor 1724/application processor 1706 may be a component of the server 310 and may include the memory 376 and/or at least one of the TX processor 316, the RX processor 370, and the controller/processor 375. In one configuration, the apparatus 1704 may be a processor chip (modem and/or application) and include just the cellular baseband processor 1724 and/or the application processor 1706, and in another configuration, the apparatus 1704 may be the entire UE (e.g., see 310 of FIG. 3) and include the additional modules of the apparatus 1704.

As discussed supra, the ML model training component 199 is configured to obtain at least one coefficient of a ML model for estimating a set of RX beams based on metrics of a subset of PO beams, and transmit the at least one coefficient associated with the ML model for a UE to estimate the metrics of the set of Rx beams using the ML model based on the at least one coefficient and metrics of a subset of PO beams. The ML model training component 199 may be within the cellular baseband processor 1724, the application processor 1706, or both the cellular baseband processor 1724 and the application processor 1706. The ML model training component 199 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1704 may include a variety of components configured for various functions. In one configuration, the apparatus 1704, and in particular the cellular baseband processor 1724 and/or the application processor 1706, includes means for obtaining at least one coefficient of a ML model for estimating a set of RX beams based on metrics of a subset of PO beams, and means for transmitting the at least one coefficient associated with the ML model for a UE to estimate the metrics of the set of Rx beams using the ML model based on the at least one coefficient and metrics of a subset of PO beams. In one configuration, the apparatus 1604, and in particular the cellular baseband processor 1624 and/or the application processor 1606, further includes means for receiving at least a part of metrics of a subset of PO beams or estimated metrics of a set of Rx beams from the UE, where the at least one coefficient of the ML model is obtained based on the at least a part of metrics of the subset of PO beams or estimated metrics of a set of Rx beams received from the UE. The means may be the ML model training component 199 of the apparatus 1704 configured to perform the functions recited by the means. As described supra, the apparatus 1704 may include the TX processor 316, the RX processor 370, and the controller/processor 375. As such, in one configuration, the means may be the TX processor 316, the RX processor 370, and/or the controller/processor 375 configured to perform the functions recited by the means.

According to some aspects of the current disclosure, the UE may be configured to measure metrics of a first subset of PO beams of at least one subset of PO beams including a plurality of PO beams from a network node, each subset of PO beams configured to form a PO pattern and the first subset of PO beams being associated with a first set of narrower RX beams of the UE, estimate metrics of the first set of narrower Rx beams using a ML model based on the metrics of the subset of PO beams, and identify at least one best Rx beam from the first set of narrower Rx beams, the at least one best Rx beam being associated with best estimated metrics among the first set of narrower Rx beams. A network node may be a ML training server, and may be configured to obtain at least one coefficient of a ML model for estimating a set of RX beams based on metrics of a subset of PO beams, and transmit the at least one coefficient associated with the ML model for a UE to estimate the metrics of the set of Rx beams using the ML model based on the at least one coefficient and metrics of a subset of PO beams.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including measuring metrics of a first subset of PO beams of at least one subset of PO beams including a plurality of PO beams from a network node, each subset of PO beams configured to form a PO pattern and the first subset of PO beams being associated with a first set of narrower RX beams of the UE, estimating metrics of the first set of narrower Rx beams using a ML model based on the metrics of the subset of PO beams, and identifying at least one best Rx beam from the first set of narrower Rx beams, the at least one best Rx beam being associated with best estimated metrics among the first set of narrower Rx beams.

Aspect 2 is the method of aspect 1, further including performing data communication using the at least one best Rx beam with the network node based on the estimated metrics of the at least one best Rx beam being greater than a first threshold value.

Aspect 3 is the method of any of aspects 1 and 2, further including reporting the metrics of the first subset of PO beams to the network node based on the estimated metrics of the at least one Rx beam being greater than a first threshold value.

Aspect 4 is the method of any of aspects 1 to 3, further including estimating metrics of a second subset of PO beams of the at least one subset of PO beams based on the estimated metrics of the at least one best Rx beam being smaller than or equal to a first threshold value, the first subset of PO beams being associated with a second set of RX beams.

Aspect 5 is the method of aspect 4, further including identifying at least one best Rx beam from the second set of Rx beams, the at least one best Rx beam being associated with best estimated metrics among the second set of Rx beams.

Aspect 6 is the method of aspect 5, further including reporting the metrics of the first subset of PO beams and the second subset of PO beams to the network node based on the estimated metric of the second best Rx beam being greater than the first threshold value.

Aspect 7 is the method of any of aspects 1 to 6, further including searching for the at least one best Rx beam associated with the best estimated metrics among the first set of Rx beams.

Aspect 8 is the method of aspect 7, where the metrics of the Rx beams are estimated at every estimation periodicity, each estimation periodicity including measuring of metrics of at least one subset of PO beams and the searching of the at least one Rx beam.

Aspect 9 is the method of any of aspects 1 to 8, further including initiating a timer prior to measuring metrics of the first subset of PO beams, where the metrics of the first set of Rx beams are estimated based on an expiration of the timer.

Aspect 10 is the method of any of aspects 1 to 9, further including measuring metrics of a third subset of PO beams from a neighboring network node, the third subset of PO beams being associated with a third set of Rx beams, and estimating metrics of the third set of Rx beams using the ML model based on the metrics of the third subset of PO beams being greater than the metrics of the first subset of PO beams by a second threshold value.

Aspect 11 is the method of any of aspects 1 to 10, where the metrics of the first set of Rx beams are estimated using the ML model based on at least one coefficient and the metrics of the subset of PO beams.

Aspect 12 is the method of any of aspects 1 to 11, further including receiving at least one coefficient associated with the ML model, the metrics of the first set of Rx beams being estimated using the ML model based on the at least one coefficient and the metrics of the subset of PO beams.

Aspect 13 is the method of aspect 12, further including transmitting at least a part of the metrics of the first subset of PO beams or estimated metrics of the first set of Rx beams to an ML model training server, where the at least one coefficient received from the ML model training server is based at least one the at least a part of the metrics of the first subset of PO beams or estimated metrics of the first set of Rx beams.

Aspect 14 is an apparatus for wireless communication including at least one processor coupled to a memory and configured to implement any of aspects 1 to 13, further including a transceiver coupled to the at least one processor.

Aspect 15 is an apparatus for wireless communication including means for implementing any of aspects 1 to 13.

Aspect 16 is a non-transitory computer-readable medium storing computer executable code, where the code when executed by a processor causes the processor to implement any of aspects 1 to 13.

Aspect 17 is a method of wireless communication at a network entity, including obtaining at least one coefficient of a ML model for estimating a set of RX beams based on metrics of a subset of PO beams, and transmitting the at least one coefficient associated with the ML model for a UE to estimate the metrics of the set of Rx beams using the ML model based on the at least one coefficient and metrics of a subset of PO beams.

Aspect 18 is the method of aspect 17, further including receiving at least a part of metrics of a subset of PO beams or estimated metrics of a set of Rx beams from the UE, where the at least one coefficient of the ML model is obtained based on the at least a part of metrics of the subset of PO beams or estimated metrics of a set of Rx beams received from the UE.

Aspect 19 is an apparatus for wireless communication including at least one processor coupled to a memory and configured to implement any of aspects 17 and 18, further including a transceiver coupled to the at least one processor.

Aspect 20 is an apparatus for wireless communication including means for implementing any of aspects 17 and 18.

Aspect 21 is a non-transitory computer-readable medium storing computer executable code, where the code when executed by a processor causes the processor to implement any of aspects 17 and 18.

What is claimed is:

1. An apparatus for wireless communication at a user equipment (UE), comprising:
a memory; and
at least one processor coupled to the memory and, based at least in part on information stored in the memory, the at least one processor is configured to:
measure metrics of a first subset of pseudo-omnidirectional (PO) beams of at least one subset of PO beams including a plurality of PO beams from a network node, each subset of PO beams configured to form a PO pattern and the first subset of PO beams being associated with a first set of narrower receive (Rx) beams of the UE;
estimate metrics of the first set of narrower Rx beams using a machine learning (ML) model based on the metrics of the subset of PO beams; and
identify at least one best Rx beam from the first set of narrower Rx beams, the at least one best Rx beam being associated with best estimated metrics among the first set of narrower Rx beams.

2. The apparatus of claim 1, wherein the at least one processor is further configured to:
perform data communication using the at least one best Rx beam with the network node based on the estimated metrics of the at least one best Rx beam being greater than a first threshold value.

3. The apparatus of claim 1, wherein the at least one processor is further configured to:
report the metrics of the first subset of PO beams to the network node based on the estimated metrics of the at least one Rx beam being greater than a first threshold value.

4. The apparatus of claim 1, wherein the at least one processor is further configured to:
estimate metrics of a second subset of PO beams of the at least one subset of PO beams based on the estimated metrics of the at least one best Rx beam being smaller than or equal to a first threshold value, the first subset of PO beams being associated with a second set of RX beams.

5. The apparatus of claim 4, wherein the at least one processor is further configured to:
identify at least one best Rx beam from the second set of Rx beams, the at least one best Rx beam being associated with best estimated metrics among the second set of Rx beams.

6. The apparatus of claim 5, wherein the at least one processor is further configured to:
report the metrics of the first subset of PO beams and the second subset of PO beams to the network node based on the estimated metric of the second best Rx beam being greater than the first threshold value.

7. The apparatus of claim 1, wherein the at least one processor is further configured to:
search for the at least one best Rx beam associated with the best estimated metrics among the first set of Rx beams.

8. The apparatus of claim 7, wherein the metrics of the Rx beams are estimated at every estimation periodicity, each estimation periodicity including measuring of metrics of at least one subset of PO beams and the searching of the at least one Rx beam.

9. The apparatus of claim 1, wherein the at least one processor is further configured to:
initiate a timer prior to measuring metrics of the first subset of PO beams,
wherein the metrics of the first set of Rx beams are estimated based on an expiration of the timer.

10. The apparatus of claim 1, wherein the at least one processor is further configured to:
measure metrics of a third subset of PO beams from a neighboring network node, the third subset of PO beams being associated with a third set of Rx beams; and
estimate metrics of the third set of Rx beams using the ML model based on the metrics of the third subset of PO beams being greater than the metrics of the first subset of PO beams by a second threshold value.

11. The apparatus of claim 1, wherein the metrics of the first set of Rx beams are estimated using the ML model based on at least one coefficient and the metrics of the subset of PO beams.

12. The apparatus of claim 1, wherein the at least one processor is further configured to:
receive at least one coefficient associated with the ML model, the metrics of the first set of Rx beams being estimated using the ML model based on the at least one coefficient and the metrics of the subset of PO beams.

13. The apparatus of claim 12, wherein the at least one processor is further configured to:
transmit at least a part of the metrics of the first subset of PO beams or estimated metrics of the first set of Rx beams to an ML model training server,
wherein the at least one coefficient received from the ML model training server is based at least one the at least a part of the metrics of the first subset of PO beams or estimated metrics of the first set of Rx beams.

14. An apparatus for wireless communication at a network entity, comprising:
a memory; and
at least one processor coupled to the memory and, based at least in part on information stored in the memory, the at least one processor is configured to:
obtain at least one coefficient of a machine learning (ML) model for estimating a set of receive (Rx) beams based on metrics of a subset of pseudo-omnidirectional (PO) beams; and
transmit the at least one coefficient associated with the ML model for a user equipment (UE) to estimate the metrics of the set of Rx beams using the ML model based on the at least one coefficient and metrics of a subset of PO beams.

15. The apparatus of claim 14, wherein the at least one processor is further configured to:
receive at least a part of metrics of a subset of PO beams or estimated metrics of a set of Rx beams from the UE,
wherein the at least one coefficient of the ML model is obtained based on the at least a part of metrics of the subset of PO beams or estimated metrics of a set of Rx beams received from the UE.

16. A method of wireless communication at a user equipment (UE), comprising:
measuring metrics of a first subset of pseudo-omnidirectional (PO) beams of at least one subset of PO beams including a plurality of PO beams from a network node, each subset of PO beams configured to form a PO pattern and the first subset of PO beams being associated with a first set of narrower receive (Rx) beams of the UE;
estimating metrics of the first set of narrower Rx beams using a machine learning (ML) model based on the metrics of the subset of PO beams; and
identifying at least one best Rx beam from the first set of narrower Rx beams, the at least one best Rx beam being associated with best estimated metrics among the first set of narrower Rx beams.

17. The method of claim 16, further comprising:
performing data communication using the at least one best Rx beam with the network node based on the estimated metrics of the at least one best Rx beam being greater than a first threshold value.

18. The method of claim 16, further comprising:
reporting the metrics of the first subset of PO beams to the network node based on the estimated metrics of the at least one Rx beam being greater than a first threshold value.

19. The method of claim 16, further comprising:
estimating metrics of a second subset of PO beams of the at least one subset of PO beams based on the estimated metrics of the at least one best Rx beam being smaller than or equal to a first threshold value, the first subset of PO beams being associated with a second set of RX beams.

20. The method of claim 19, further comprising:
identifying at least one best Rx beam from the second set of Rx beams, the at least one best Rx beam being associated with best estimated metrics among the second set of Rx beams.

21. The method of claim 20, further comprising:
reporting the metrics of the first subset of PO beams and the second subset of PO beams to the network node based on the estimated metric of the second best Rx beam being greater than the first threshold value.

22. The method of claim 16, further comprising:
searching for the at least one best Rx beam associated with the best estimated metrics among the first set of Rx beams.

23. The method of claim 22, wherein the metrics of the Rx beams are estimated at every estimation periodicity, each estimation periodicity including measuring of metrics of at least one subset of PO beams and the searching of the at least one Rx beam.

24. The method of claim 16, further comprising:
initiating a timer prior to measuring metrics of the first subset of PO beams,
wherein the metrics of the first set of Rx beams are estimated based on an expiration of the timer.

25. The method of claim 16, further comprising:
measuring metrics of a third subset of PO beams from a neighboring network node, the third subset of PO beams being associated with a third set of Rx beams; and
estimating metrics of the third set of Rx beams using the ML model based on the metrics of the third subset of PO beams being greater than the metrics of the first subset of PO beams by a second threshold value.

26. The method of claim 16, wherein the metrics of the first set of Rx beams are estimated using the ML model based on at least one coefficient and the metrics of the subset of PO beams.

27. The method of claim 16, further comprising:
receiving at least one coefficient associated with the ML model, the metrics of the first set of Rx beams being estimated using the ML model based on the at least one coefficient and the metrics of the subset of PO beams.

28. The method of claim 27, further comprising:
transmitting at least a part of the metrics of the first subset of PO beams or estimated metrics of the first set of Rx beams to an ML model training server,
wherein the at least one coefficient received from the ML model training server is based at least one the at least a part of the metrics of the first subset of PO beams or estimated metrics of the first set of Rx beams.

29. A method of wireless communication at a network entity, comprising:
obtaining at least one coefficient of a machine learning (ML) model for estimating a set of receive (Rx) beams based on metrics of a subset of pseudo-omnidirectional (PO) beams; and
transmitting the at least one coefficient associated with the ML model for a user equipment (UE) to estimate the metrics of the set of Rx beams using the ML model based on the at least one coefficient and metrics of a subset of PO beams.

30. The method of claim 29, further comprising:
receiving at least a part of metrics of a subset of PO beams or estimated metrics of a set of Rx beams from the UE,
wherein the at least one coefficient of the ML model is obtained based on the at least a part of metrics of the subset of PO beams or estimated metrics of a set of Rx beams received from the UE.
